(19) United States
(12) Patent Application Publication
(10) Pub. No.: US 2026/0092795 A1
(43) Pub. Date: Apr. 2, 2026

(54) ACOUSTIC METHOD AND SYSTEM FOR TRACKING OBJECTS AND IDENTIFYING TRENDS IN TRACKS OF TRACKED OBJECTS FOR BEHAVIOURAL AND RELATIONSHIP INFORMATION

(71) Applicant: FIBER SENSE LIMITED, Mosman, NSW (AU)

(72) Inventor: Mark Andrew ENGLUND, Mosman, New South Wales (AU)

(21) Appl. No.: 19/113,367

(22) PCT Filed: Sep. 21, 2023
(86) PCT No.: PCT/AU2023/050919

§ 371 Date: Mar. 19, 2025

(30) Foreign Application Priority Data
Sep. 21, 2022 (AU) 2022902736

(51) Int. Cl. G01D 5/353; G01H 9/00

(52) U.S. Cl. CPC G01D 5/35358; G01D 5/35374; G01H 9/004

(57) ABSTRACT

Described herein in is an acoustic system and method for tracking and identifying trends or behavioural characteristics or properties of multiple sound producing targets or objects across a geographical area. The method and system may be used independently of or as a supplement to bespoke tracking technology associated with such objects or targets. The acoustic method includes repeatedly transmitting, at multiple instants, interrogating optical signals into each of one or more optical fibres distributed across the geographical area and forming at least part of an installed fibre-optic communications network. Next the method includes receiving, during an observation period following each of the multiple instants, returning optical signals scattered in a distributed manner over distance along the one or more of optical fibres, the scattering influenced by acoustic disturbances caused by the multiple objects within the

### FIELD OF THE INVENTION

The present disclosure generally relates to an acoustic method and system for identification and tracking of objects and using these tracks and tracked features to identify trends in tracked objects or targets, properties and relationships of the tracked object or targets to other tracked objects or targets or locations. In particular, the present disclosure relates to an acoustic method and system for identifying and tracking objects or targets such as vehicles and identifying trends or behaviours based or relationships to other objects or locations based on such tracking.

### BACKGROUND OF THE INVENTION

Fibre-optic distributed acoustic sensing can detect acoustic events in surrounding regions along an optical fibre and the position of these events can be mapped to accurate latitude and longitude positions in an area through time of flight measurements to the event along the optical fibre and the location of the fibre path. An acoustic event can be caused by incidents such as digging near a gas pipe, water pipe or a power cable, or pedestrian and road traffic activities. Different types of incidents may cause different acoustic signatures in the acoustic event. Monitoring of acoustic events therefore allows for alerts to be generated for the prevention or identification of these incidents, or for tracking of road users in the case of pedestrian and road traffic.

Known wide area surveillance systems include those employing visual means, which collect visual information for surveillance. For example, closed-circuit television (CCTV) cameras have been used to monitor city streets. Each CCTV camera can provide one localised view of a streetscape at any one time with a depth of field of view determined by the optics of the CCTV camera. In case of a system with multiple CCTV cameras, the blind spots or the visually least clear spots in the city are potentially locations mid-way between CCTV cameras or outside a CCTV camera's field of view. As another example, street views captured by a camera system mounting on a moving vehicle can provide visibility of some of these blind spots, but the street view images are static and impractical to be regularly updated for live monitoring. As yet another example, satellite imagery can provide a city-wide bird's eye view of objects that are in the satellite's unobstructed line-of-sight. Targets or events that are visually obstructed (e.g. underground, under thick clouds, within a building or under bridges or flyovers) would therefore lack surveillance visibility from satellite images, which are also static.

Other known wide area surveillance systems include those employing radio means. For example, cellular signals from mobile devices carried by users may be used to provide surveillance information on, for instance, the number of people in proximity of, and their locations from, a cell tower by determining the number of cellular connections and signal strength or signal information. The surveillance information obtainable from cellular signals may not be a reliable representation of the true number of people and their approximate locations with respect to a cell tower. A person in the area may well carry none or multiple mobile devices or have their mobile device switched off. Further, mobile device signals vary in strength across different devices and some may be penetrating or reflected off buildings such that the signal strength becomes an unreliable indicator of distance. Not every person would be carrying a single, transmitting mobile device with consistent signal power in radio line-of-sight of a cell tower at all times. In addition mobile devices are not reliably able to convey classification data about the object they are associated with, in that they may be associated with more than one object.

Numerous types of vehicle-based tracking and navigation systems exist, and have proliferated for the management and control for intelligent transportation systems (ITS). These can make use of GPS, vehicle detection (VD) and cellular floating vehicle data (CFVD). A disadvantage of these systems is that they are not ubiquitous, are not always reliable (due to signal drop-outs from urban canyon effects and the like), and the ability to track and monitor all vehicles is not system agnostic.

A further example is in the form of arrays of inductive loops deployed at traffic light intersections for detection of vehicles on roads. This system can only detect metal vehicles and as such cannot detect pedestrians and other biologics, and can only detect across limited zones.

Lidar looking down on city areas has similar limitations as a satellite as it is line of sight only and will have blind spots. It is also non trivial to detect and classify the presence of distinct objects from the measurement field (e.g. cars, pedestrians, bicycles, trucks etc.).

Reference to any prior art in the specification is not, and should not be taken as, an acknowledgment or any form of suggestion that this prior art forms part of the common general knowledge in any jurisdiction or that this prior art could reasonably be expected to be understood, regarded as relevant and/or combined with other pieces of prior art by a person skilled in the art.

### SUMMARY OF THE INVENTION

In one aspect there is provided an acoustic method of tracking and identifying trends or behavioural characteristics or properties of multiple sound producing targets or objects across a geographical area, independently of or as a supplement to bespoke tracking technology associated with such objects or targets, the method including: repeatedly transmitting, at multiple instants, interrogating optical signals into each of one or more optical fibres distributed across the geographical area and forming at least part of an installed fibre-optic communications network; receiving, during an observation period following each of the multiple instants, returning optical signals scattered in a distributed manner over distance along the one or more of optical fibres, the scattering influenced by acoustic disturbances caused by the multiple objects within the observation period; demodulating acoustic data from the optical signals; processing the acoustic data to identify tracks made by the objects over a period of time across the area; analysing one or more characteristics of the tracks or tracked features, including start and end points, to identify relationship links between the dynamic objects and their locations or between the dynamic objects and other static or dynamic objects or fixtures or events in the geographic area for real time, historic or predictive analysis.

Relationship links may include any relationship including but not limited to temporal, causal or identification-related links.

It will be understood that start and end points are defined not only with reference to the actual points of the tracks where the objects may have commenced or ended their journey but also with reference to the start and end points of the tracks with reference to the particular area over which the objects are being investigated or monitored.

Dynamic real time representations of the objects and/or tracks may be rendered on a GIS overlay or map.

The method may include identifying and correlating tracks made by the same object based on one or more characteristics of the tracks or the object to identify trends or behavioural characteristics of the object over time.

The characteristics of the tracks may be selected from a group including, in addition to start and end points, at least one of the corresponding starting and end times, acoustic signature classification, displacement, velocity and acceleration profile, inter-trip frequency, and time of travel.

The method may include the step of classifying the sound producing targets or objects or events as symbols representative of the sound producing targets or objects or events and storing the symbols as part of the datasets in a digital symbol index database.

The method may include generating alert criteria associated with respective acoustic signatures, and triggering an alarm or warning in the event of the alert criteria being triggered.

The one or more optical fibres may include one or more unlit optical fibres or unused spectral channels in the installed urban or metropolitan fibre-optic communications network, and the fibre-optic optic communications network is a high density public telecommunications network approaching ubiquitous or substantially continuous street coverage.

The method may further include processing or fusing or representing the acoustic datasets together with surveillance data obtained from at least one non-acoustic sensing system.

Classification data is obtained or a classification algorithm may be trained using data from the at least one non-acoustic sensing system.

The non-acoustic sensing system may include at least one of a moving image capturing system, a machine vision system, a satellite-based navigation system including GPS, a satellite imagery system, a closed-circuit television system, a cellular signal-based system, a Bluetooth system, inductive loop detectors, magnetic detectors, and location based social networks.

The alert criteria may be generated using a semantics engine to assess a threat or alert level associated with a target, and the alarm may be generated in the event of the threat or alert level exceeding a threshold.

Registration data may be fed into the semantics engine to enable threat or alert levels associated with registered objects to be reduced or filtered out.

According to a second aspect there is provided an acoustic method of tracking and identifying trends or behavioural characteristics of multiple sound producing targets or objects in a geographical area, comprising: sensing and locating at least one acoustic event; identifying the event; identifying one or more dynamic objects potentially associated with the event; the identifying including tracking the one or more dynamic objects using a distributed acoustic sensor; using tracking information and/or non-acoustic data to establish or confirm relationship links between the dynamic objects and the event, and their locations, or between the dynamic objects and other static or dynamic objects or fixtures in the geographic area; associating acoustic signatures with the dynamic objects using at least one non-acoustic sensor; and storing the acoustic and non-acoustic data for retrieval and analysis.

The method may include processing the acoustic data and classifying it in accordance with target classes or types to generate a plurality of datasets including classification, temporal and location-related data; and storing the datasets in parallel with raw acoustic data which is time and location stamped so that it can be retrieved for further processing and matched with the corresponding datasets to provide real time, historic and predictive data.

The optical data may be processed into acoustic data at a resolution based on the temporal and location based parameters, the processing including retrieving the acoustic data at a desired resolution for near beam forming at a desired location, either historically or in real time.

The method may further include detecting when tracking of one or more objects is suspended or ambiguated, and using a semantics engine to reactivate or disambiguate the tracking.

The tracking may be ambiguated or suspended as a result of clustering of acoustic objects, including pedestrians or vehicles slowing down or stopping, and the semantics engine is configured to disambiguate or reactivate the tracking by assessing and comparing pre-and post-clustering conditions based on at least one of acoustic signatures, displacement, velocity or acceleration profiles, or non-acoustic identification means.

Tracking may also be ambiguated or suspended as a result of acoustic objects temporarily no longer being acoustically detected, including pedestrians or vehicles moving away from network coverage, and the semantics engine is configured to disambiguate or reactivate the tracking by assessing and comparing pre-and post-non-detection conditions based on at least one of acoustic signatures, displacement, velocity or acceleration profiles, and geographic location based on map overlay.

The acoustic event may be an excavation event, the dynamic objects are excavators, the excavators being registered or unregistered depending on pre-recordal of excavation locations associated with the diggers being stored in a database, with excavation activity from non-registered diggers in the region of a fibre optic cable functioning as the distributed acoustic sensor being detected and responded to more rapidly than activity from registered diggers.

According to a third aspect there is provided an acoustic system for tracking and identifying trends or behavioural characteristics of multiple sound producing targets or objects across a geographical area, the system including: an optical signal transmitter arrangement for repeatedly transmitting, at multiple instants, interrogating optical signals into each of one or more optical fibres distributed across the geographical area and forming at least part of an installed fibre-optic communications network; an optical signal detector arrangement for receiving, during an observation period following each of the multiple instants, returning optical signals scattered in a distributed manner over distance along the one or more of optical fibres, the scattering influenced by acoustic disturbances caused by the multiple targets within the observation period; a processing unit for demodulating acoustic data from the optical signals, for processing the acoustic data to identify tracks made by the objects over a period of time across the area; and for analysing one or more characteristics of the tracks, including start and end points, to identify relationship links between the dynamic objects and their locations or between the dynamic objects and other static or dynamic objects or fixtures in the geographic area for real time, historic or predictive analysis, and a storage unit for storing the acoustic data and the analysed datasets.

According to a fourth aspect there is provided a system for carrying out the method of the first aspect.

According to a fifth aspect there is provided an acoustic system for tracking and identifying trends or behavioural characteristics of multiple sound producing targets or objects across a geographical area, the system including: a distributed acoustic sensor for sensing at least one acoustic event, the distributed acoustic sensor including an optical signal transmitter arrangement for repeatedly transmitting, at multiple instants, interrogating optical signals into each of one or more optical fibres distributed across the geographical area and forming at least part of an installed fibre-optic communications network; an optical signal detector arrangement for receiving, during an observation period following each of the multiple instants, returning optical signals scattered in a distributed manner over distance along the one or more of optical fibres, the scattering influenced by acoustic disturbances caused by the multiple targets within the observation period; a processing unit configured to demodulate acoustic data from the optical signals, to process the acoustic data to locate the at least one acoustic event, to identify the event and to identify one or more dynamic objects potentially associated with the event, wherein the identifying includes tracking the one or more objects using the distributed acoustic sensor and using tracking information and/or non-acoustic data to establish or confirm relationship links between the dynamic objects and the event, or between the dynamic objects and other static or dynamic objects or fixtures in the geographic area; and wherein the processing unit is further configured to associate acoustic signatures with at least one of the one or more dynamic objects using at least one non-acoustic sensor; and a storage unit for storing the acoustic data, non-acoustic data and analysed datasets for retrieval and analysis.

According to a sixth aspect there is provided a system for carrying out the method of the second aspect.

The acoustic event is associated with an accident or crime scene, and the dynamic objects are vehicles and/or pedestrians, and a further aspect may extend to the reconstruction of such accident or crime scene using the above systems and methods, using third party identification data.

Any identification steps as far as they relate to the collecting of personal information in contravention of any relevant privacy legislation may be performed by third parties such as law enforcement agencies, where exceptions to the collection of such data arise. This is applicable primarily to the collection of non-acoustic data of the type described.

### BRIEF DESCRIPTION OF THE DRAWINGS

FIG. 1 illustrates an example of a system for tracking acoustic objects.

FIGS. 2A, 2B, 2C, 2D, 2E and 2F illustrate examples of methods of providing and processing digital data for tracking objects and identifying trends or behaviour patterns.

FIG. 3A illustrates schematically a transmission sequence of interrogating optical signals at multiple instants and a sequence of corresponding observation windows.

FIG. 3B illustrates schematically an example of amplitude vs distance plots provided by a system of the present disclosure.

FIG. 4A illustrates a schematic distribution geometry of optical fibres utilised for obtaining digital data.

FIG. 4B illustrates another schematic distribution geometry of optical fibres utilised for obtaining digital data.

FIGS. 5A and 5B illustrate distribution geometry with a Google maps overlay of part of Sydney and typical graphic representations of symbols.

FIG. 6 illustrates one example of a subscriber interface for use in an embodiment of the method and system.

FIG. 7 illustrates a partly schematic distribution geometry showing how virtual paths are created from an established optical fibre network for servicing individual subscribers in a geographic area.

FIG. 8 shows a partly schematic diagram of a fibre optic cable with phased array sensing beams.

FIG. 9 shows a selected zone of Google® Maps provided with part of an existing fibre optic cable network.

FIG. 10 shows a plot of vehicle tracks or traces over a selected zone for a 30 minute period.

FIG. 11 shows highlighted tracks made by the same vehicle over the zone in three separate return journeys.

FIG. 12 shows the tracks tagged with track identification numbers.

FIG. 13 shows various representations of a more detailed analysis of one of the vehicle tracks.

FIGS. 14A and 14B show respective highlighted traces and a map indicating a return trip by an identified vehicle between start and end points.

FIGS. 15A and 15B show maps and corresponding traces indicating real time data including multiple vehicle detection and dynamic display.

### DETAILED DESCRIPTION OF THE EMBODIMENTS

The present disclosure relates to an acoustic method and system for the provision of digital data for the purposes of tracking targets and identifying trends and behavioural characteristics of tracked targets. The inventor has recognised shortcomings associated with visual or radio surveillance and monitoring techniques mentioned in the background. Disclosed herein is a method and system for providing surveillance data devised in view of these issues. The present disclosure provides an alternative method and system to those techniques or systems mentioned in the background, and/or a supplemental method and system that can be used in conjunction with those techniques or systems.

The surveillance data can relate to real-time acoustic data for monitoring targets. Alternatively or additionally, the surveillance data relates to historic acoustic data for later retrieval and searching. In general, “targets” include any acoustic objects that vibrate and therefore generate detectable acoustic signals, such as vehicles (generating tyre/engine noise), pedestrians (generating footsteps), trains (generating rail track noise), building operations (generating operating noise), and road, track or infrastructure works (generating operating noise). They also include events caused by targets, such as by non-limiting example car crashes, gunshots caused by a handgun or other weapon, break-ins or other noise-generating criminal activity, or an explosion caused by explosives (generating high-pressure sound waves and reverberation).

The disclosed system and method make use of fibre optic distributed acoustic sensing to provide spatial and temporal surveillance and monitoring data within a geographical area, such as a city, utilising one or more optical fibres distributed across the geographical area. Such a sensing technique relies on the occurrence of a nearby acoustic event causing a corresponding local perturbation of refractive index along an optical fibre. The required proximity of the acoustic event depends on the noise floor of the sensing equipment, the background noise, and the acoustic properties of the medium or media between the acoustic event and the optical fibre. Due to the perturbed refractive index between scattering elements in the fibre core, an optical interrogation signal transmitted along an optical fibre and then back-scattered in a distributed manner (e.g. via Rayleigh scattering or other similar scattering phenomena) along the length of the fibre will manifest in fluctuations (e.g. in intensity and/or phase) over time in the reflected light. The magnitude of the fluctuations relates to the severity or proximity of the acoustic disturbance. The timing of the fluctuations along the distributed backscattering time scale relates to the location of the acoustic event.

It will be appreciated that by the term ‘distributed acoustic sensing’ is meant sensing a source that has an acoustic component. This acoustic component may translate to a vibrational or seismic component when travelling through the earth or a solid body before causing local perturbation in a buried fibre optic cable.

Reference to acoustic data in this disclosure should be read as including any propagating wave or signal that imparts a detectable change in the optical properties of the sensing optical fibre. These propagating signals detected in the system may include signal types in addition to acoustics such as seismic waves, vibrations, and slowly varying signals that induce for example localised strain changes in the optical fibre. The fundamental sensing mechanism in one the preferred embodiments is a result of the stress-optic effect but there are other scattering mechanisms in the fibre that this disclosure may exploit such as the thermo-optic effect and magneto-optic effect.

Reference to acoustic data also needs to be read in context with optical data.

The raw optical data in the preferred embodiment is stream of repeating reflection sets from a series of optical pulses directed down the sensing fibre. These reflection sets are sampled at very high rates (in the order of gigabits per second) and are demodulated into a series of time windows that correspond to a physical location along the optical fibre. The data in these time windows is used to demodulate the integrated strain along the local length of the fibre at that time. The integrated strain contains signals such as acoustics, seismic, vibration and other signals that induce strain on the fibre. The integrated strain data from demodulation results in much smaller data rates than the optical data collected (in the order of megabits per second). The extent of the time window bins is selectable and is done so based on compromises between spatial resolution of sensor channels, signal frequency range, dynamic range, and maximum length range of the system. While the acoustic data is more efficient to store in terms of data set size, storing the optical data set may allow for any one of the demodulation parameters to be changed and new demodulated data generated with a different set of selections for spatial resolution of sensor channels, signal frequency range, dynamic range, maximum length range of the system. This flexibility is important to optimise the system for disparate sensing tasks that may require particular locations or areas to be re-processed with different configurations that enhance detection, classification, tracking, counting and/or further signal analysis of acoustic sources of interest.

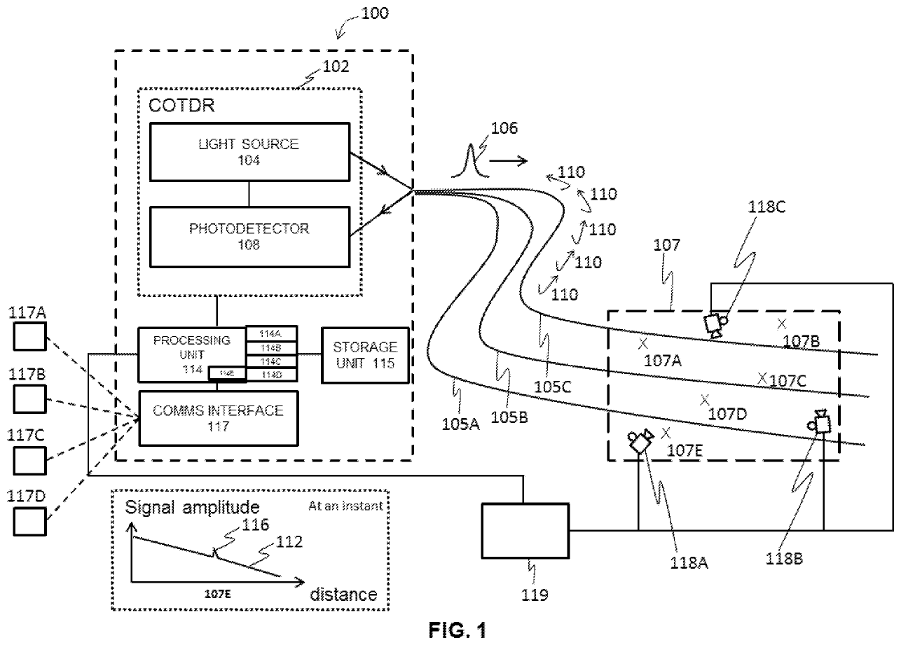

In one example, a system 100 for use in distributed acoustic sensing (DAS) is illustrated in FIG. 1. The DAS system 100 includes a coherent optical time-domain reflectometer (C-OTDR) 102. The C-OTDR 102 includes a light source 104 to emit an optical interrogation field 106 in the form of a short optical pulse to be sent into each of optical fibres 105A, 105B and 105C. The optical fibres 105A, 105B and 105C are distributed across a geographical area 107. The C-OTDR 102 includes a photodetector 108 configured to detect the reflected light 110 scattered in a distributed manner and produce a corresponding electrical signal 112 with an amplitude proportional to the reflected optical phase that is converted to intensity resolved over time. The time scale may be translated to a distance scale relative to the photodetector 108. An inset in FIG. 1 illustrates a schematic plot of such signal amplitude over distance at one particular instant. The DAS system 100 also includes a processing unit 114, within or separate from the C-OTDR 102, configured to process the acoustic fluctuations 116 in the electrical signal 112.

These acoustic fluctuations are acoustic signals that contain a number of different acoustic frequencies at any one point and also along a series of different spatial points that the processing unit will convert to a digital representation of the nature and movement of the sound targets around the cable grid. In contrast to scalar measurands such as temperature (which typically don't provide any dynamic information above a few Hz, so it is not feasible to determine what type of heat sources are around the cable and how they are moving), acoustic signals contain a significant number of frequency components (up to many kHz, which are unique and distinguishable to a specific target type) and vector information, i.e. the amplitude information derived from the Fourier domain (of single channels) and the multi-channel time domain (spatial information such as direction of the “target” and the spatial position for facilitating GIS overlay and velocity parameters (speed and acceleration).

The digitised electrical signal 112, any measured fluctuations 116 and/or processed data associated therewith may be stored in a storage unit 115. The storage unit 115 may include volatile memory, such as random access memory (RAM) for the processing unit 114 to execute instructions, calculate, compute or otherwise process data. The storage unit 115 may include non-volatile memory, such as one or more hard disk drives for the processing unit 114 to store data before or after signal-processing and/or for later retrieval. The processing unit 114 and storage unit 115 may be distributed across numerous physical units and may include remote storage and potentially remote processing, such as cloud storage, and cloud processing, in which case the processing unit 114 and storage unit 115 may be more generally defined as a cloud computing service.

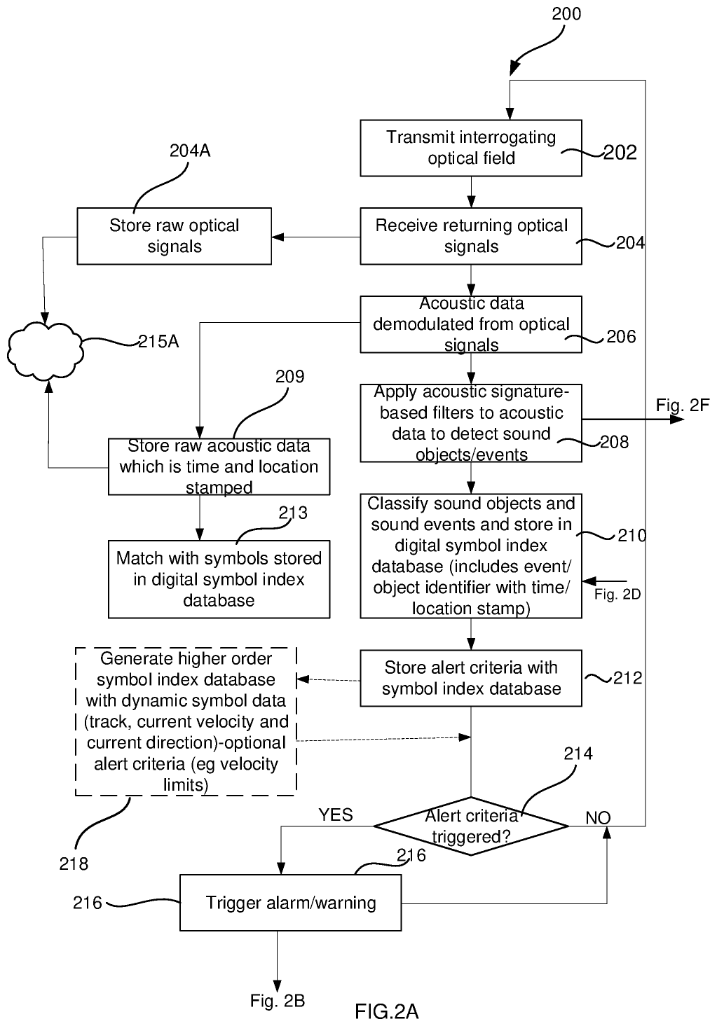

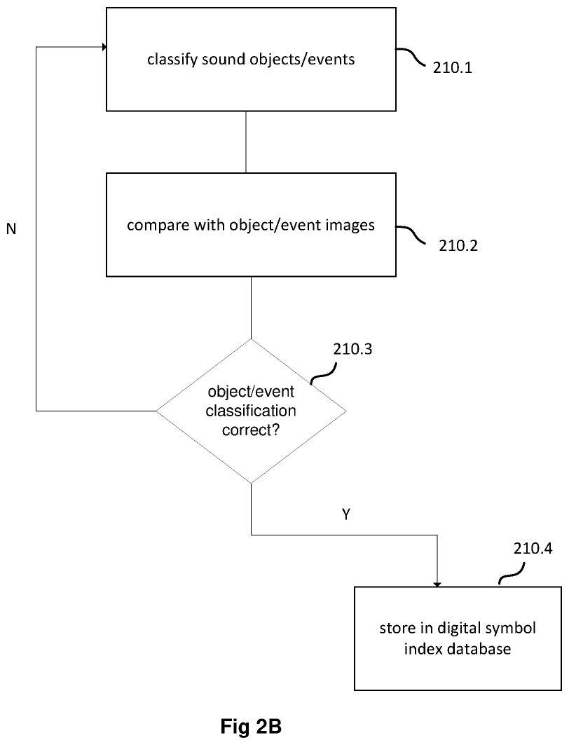

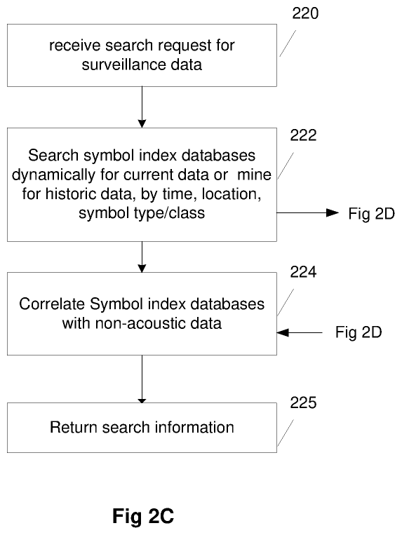

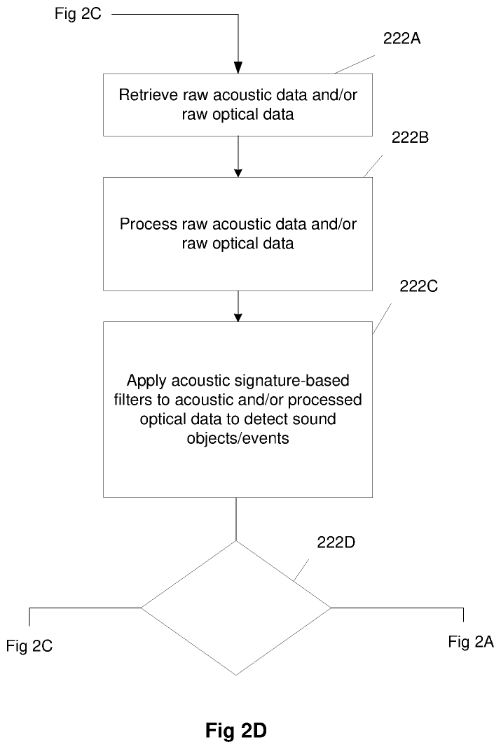

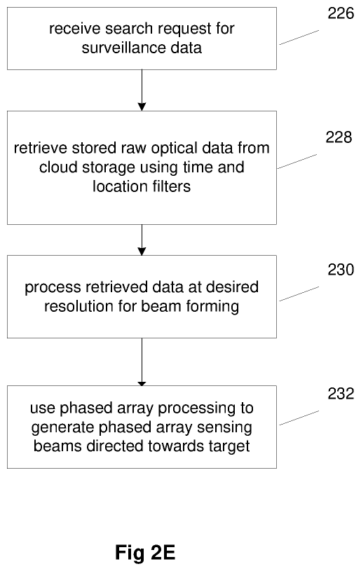

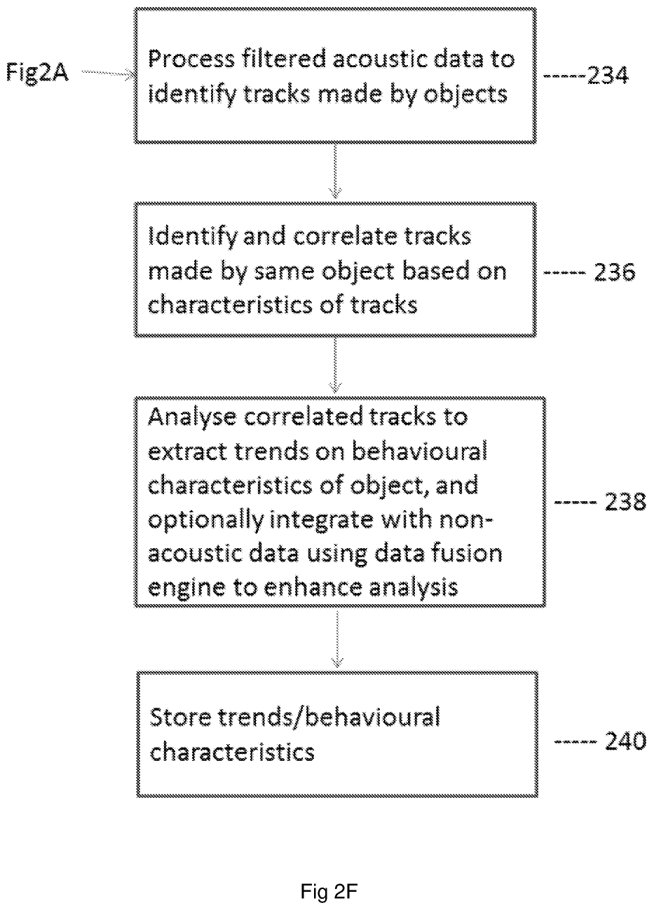

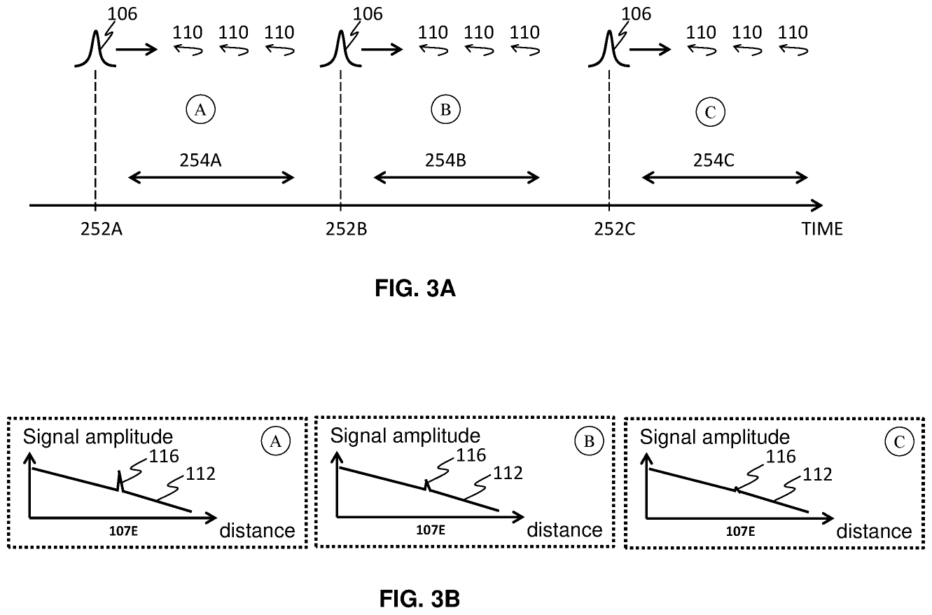

FIGS. 2A, 2B, 2C, 2D, 2E, 2F and 3A illustrate various examples of the disclosed method 200. The disclosed method 200 includes the step 202 of transmitting, at multiple instants 252A, 252B and 252C, interrogating optical signals or fields 106 into each of one or more optical fibres (e.g. one or more of 105A, 105B and 105C) distributed across a geographical area (e.g. 107), which is typically an urban environment. The optical fibres typically form part of a public optical fibre telecommunications network which provides a high degree of dense street coverage (practically ubiquitous and at the very least co-extensive with the network) in an urban and particularly inner city environment. The disclosed method 200 also includes the step 204 of receiving, during an observation period (254A, 254B and 254C) following each of the multiple instants 252A, 252B and 252C, returning optical signals (e.g. 110) scattered in a distributed manner over distance along the one or more of optical fibres (e.g. one or more of 105A, 105B and 105C).

This configuration permits determination of an acoustic signal (amplitude, frequency and phase) at every distance along the fibre-optic sensing cable. In one embodiment, the photodetector/receiver records the arrival times of the pulses of reflected light in order to determine the location and therefore the channel where the reflected light was generated along the fibre-optic sensing cable. This phased array processing may permit improved signal-to-noise ratios in order to obtain improved detection of an acoustic source, as well as the properties of the acoustic source.

Substantially total sensing area coverage of a particular city area is an important aspect of this disclosure. The density of the grid formed by the fibre paths may be limited in certain geographies owing to existing buildings or facilities or other restrictions. Beam forming through phased array processing of an ensemble of adjacent sensor channels is able to significantly extend the sensing range perpendicular to a given position along the fibre. Beamforming can therefore be used to ensure the area that is covered by the sensing range of the fibre grid has minimal gaps or areas where a sound source may not be detected.

Beamforming techniques involve the addition of phase-shifted acoustic fields measured at different distances (or channels) along the fibre-optic sensing cable by injecting a series of timed pulses. These beamforming techniques may result in several intersecting narrow scanning beams that may yield direction of the acoustic source and its location relative to the fibre-optic sensing cable in two or three dimensions in order to selectively monitor different zones in the acoustic field with improved array gain range and enhanced detection capabilities, with the scanning beams being designed to supplement and improve coverage. In high traffic areas or dense sensing environments requiring close monitoring beamforming techniques may also be effectively employed as they provide high levels of spatial discrimination. A particular type of beamforming referred to as near field beamforming may also be applicable to the case described wherein the assumption of plane wave arrival from far field sources is no longer true and curved wave fronts of near field sources are exploited to localise the sound source in 2 or 3 dimensions relative to the optical fibre cable.

The disclosed method 200 also includes the step 206 of demodulating acoustic data from the optical signals 110 associated with acoustic disturbances caused by the multiple targets detected within the observation period (254A, 254B and 254C).

At step 208 acoustic signature-based filters 114A, 114B, 114C and 14D are applied to the acoustic data to detect acoustic objects/events. These filters could be in the form of software-based FIR (finite impulse response) or correlation filters, or classification could alternatively be implemented using big data and machine learning methodologies. This latter approach would be applicable where higher levels of discrimination of sound objects is required, such as details of vehicle type or sub-class or sub-classes of other objects.

At step 209, raw or unfiltered acoustic data is fed in parallel from demodulation step 206 and stored in the storage unit 215, which may include cloud-based storage 215A. It is similarly time and location stamped, so that it can be retrieved at a later stage to be matched at 213 with symbols stored in a digital symbol index database for allowing additional detail to be extracted where possible to supplement the symbol data.

In addition or as an alternative to the raw acoustic data being stored, raw optical signals may be digitised by an A/D converter and stored as raw optical data at step 204A prior to demodulation in cloud storage facility 215A. Whilst this will require substantially more storage capacity it has the advantage of preserving the integrity of all of the backscattered optical signals/data without losing resolution as a result of sampling frequencies and the like, and retaining all time and location-based data. This stored optical data may then be retrieved for forensic analysis at a later stage. An advantage of storing raw optical data is that the above described beamforming techniques may be applied to the data to result in higher resolution detection and monitoring. If stored, the optical data can be retrieved, processed and re-processed to provide new acoustic data that can enhance beamforming performance by adjusting or reducing channel spacing and adjusting or reducing frequency range, for example.

In one embodiment complete digital demodulation architectures may be implemented where the digitisation of the return signals is done early in the demodulation functions and most of the key demodulation functions are then carried out digitally (as opposed to using analogue hardware components) in high speed electronic circuits including FPGAs (field programmable gate arrays) and ASICs (application specific integrated (electronic) circuits). The demodulated optical data may then be stored digitally which provides for greater flexibility than using a fixed analogue demodulator, as well as greater coverage in being able to store and process higher resolution data.

At step 210, symbols representative of sound objects and/or sound events are generated and stored in the digital symbol index database. Each symbol index includes an event/object identifier with time and location stamp). Event/object identifiers could include by way of example only pedestrians, cars, trucks, excavators, trains, jackhammers, borers, mechanical diggers, manual digging, gunshots, glass breakage associated with break-ins and the like. The series of different software-based correlation filters 14A-14D is provided for each classification type above (each correlation filter is tuned to particular characteristics in the acoustic time series and acoustic frequency domain) and once the output of one of these software based filters reaches a threshold, a detection and classification event is triggered in the system. The system now has a digital representation of an object or event with properties such as what the object or event is, where it is located geographically, how fast is it moving, if at all, and a host of other properties that can be deduced from the acoustic data associated with this object or event.

Alert criteria are stored with the symbol index database at step 212, with each symbol having at least one associated alert criterion (threshold amplitude/frequency). The alert criteria may form part of a semantics or context engine 114E in the processing unit which processes a number of factors which can be used to determine the level of threat or danger associated with an event, and thereby deliver actionable information. For example, in the case of an excavator conducting an excavation, the speed and direction of movement of the excavator is factored in. Other information received via the communications interface 117 could include the identity of the excavator/entity performing the works so that it could be identified and alerted in the event of it being in danger of damaging or severing the cable. In addition if the excavator was associated with a known and reliable contractor then this would be factored into the decision making process.

Other information could include that relating to the location of all public works being conducted in the geographic area, so that an excavation or intrusion event detected at a location where there are no known operations or at a time of day where no operations are expected is allocated a higher alert or alarm status.

The semantics engine is also used to resolve situations where tracking of one or more objects such as vehicles or pedestrians is suspended or ambiguated. This may occur as a result of clustering as a result of pedestrians or vehicles slowing down or stopping. In this case the acoustic footprints of the pedestrians or vehicles merge and may also reduce in amplitude as the vehicles or pedestrians decelerate and then stop, as is the case with vehicles at a traffic light or in heavy traffic conditions. The semantics engine is configured to disambiguate or reactivate the tracking by assessing and comparing pre-and post-clustering conditions based on at least one of acoustic signatures of the vehicles or pedestrians, displacement, velocity or acceleration profiles, or non-acoustic identification means such as CAV, GPS, Bluetooth or the like. In the case of clustering, the vehicles'individual footprints may be identifiable once more when they accelerate and move apart from one another, they can be identified once more by their specific acoustic signature or velocity or acceleration profiles.

Tracking may also be ambiguated or suspended as a result of acoustic objects temporarily no longer being acoustically detected, including pedestrians or vehicles moving away from network coverage, by for example travelling along a street or laneway that is not provided with a fibre optic cable. The semantics engine is configured to reactivate the tracking by assessing and comparing pre-and post-non-detection conditions based on at least one of acoustic signatures, displacement, velocity or acceleration profiles, and geographic location based on map overlay. The latter is relevant when a vehicle for instance moves form a tracked to an untracked condition along a street which is clearly identifiable, and the emergence of the vehicle back onto a street with fibre-optic network coverage is predicable both geographically and temporarily by virtue of using the vehicle's velocity profile.

The location of public and other works being conducted could be derived from a regularly updated database 117D linked via communications interface 117 in which stored data relating to all excavators which have registered with a “Dial before you Dig” or similar program which may include the details of the individual excavators/diggers, digging locations and digging times. Registered sites would be given low or no alarm priority, and all excavation activity detected from unregistered sites would be given a high alarm priority status which would result in a rapid response procedure with a vehicle being dispatched immediately to the affected site, in particular where vulnerable infrastructure such as fibre optic cable was present.

Another example of actionable information would be information which showed that the excavator or other vehicle was being driven or operated in an erratic or unusual manner, even if it was registered or was operating in a registered area. Threat levels may be indicated both graphically using say a familiar green, orange and red colour scheme, and flashing symbols and audibly using audible alarms of progressively increasing volume.

At step 218 a higher order symbol index database is optionally generated with dynamic symbol data (current velocity and current direction) and optional alert criteria (e.g. velocity limits). Again the higher order symbol index database could be associated with the context engine 114E to assess alert criteria, including the above-mentioned high unregistered excavator alert. If alert criteria are triggered at 214, an alarm or warning is triggered at 216, and the cycle is repeated with transmission step 202. It will be appreciated that there may be more than one trigger event per cycle. Depending on the alarm or warning, different rapid response protocols and procedures may be adopted, including the immediate dispatching of an appropriate vehicle and team.

This process of forming a “digital representation of what is present” is possible to do with machine vision acting on a video feed but is generally more complicated and expensive to implement (significant computational overhead and a large number of camera feeds and massive bandwidth required, due to increase in carrier frequency from kHz in the case of sound to THz in the case of light. Sound doesn't have the ability to image the fine physical features of a given object that light can render in a video or from related techniques such as a LIDAR feed. However over a wide urban area like a city or group of cities, sound including seismic has been identified as an ideal and very efficient field (among many choices-light, RF, magnetic, electric, temperature) to detect a wide range of objects and events and their properties. A major advantage is that the only requirement is that the object emits an acoustic or seismic signal. No additional opt-in or infrastructure/object-based requirements exist so that potentially all objects can be tracked. This is key to the physical world search (PWS) capability described in this disclosure being feasible once a large scale acoustic sensor system is fully deployed, as well as to real time tracking adopting such a system.

The recorded electronic data includes acoustic information representing approximate locations (e.g. 107A to 107E) of the multiple targets within or near the geographical area (e.g. 107) and associated with the multiple instants 252A, 252B and 252C. The approximate locations (e.g. 107A to 107E) are inferred from the distance along the one or more optical fibres (e.g. one or more of 105A, 105B and 105C). FIG. 3B illustrates a schematic plot of signal amplitude over distance for each of the instants 252A, 252B and 252C.

In one arrangement, the optical fibres utilised to facilitate gathering surveillance data may form or be a part of a network of optical fibres. The work may be an established fibre-optic communications network, in recognition of a scenario where fibre-optic communications networks are often installed with more communications capacity than required at the time of installation. In one form, the under-utilised communications capacity includes one or more unlit optical fibres. For example, a fibre-optic bundle may include multiple optical fibres, one or more of which are configured to carry communications information while the others remain unlit until the lit ones reaches capacity. These unlit optical fibres may therefore be borrowed or otherwise utilised for obtaining surveillance information according to the present disclosure. In another form, the extra communications capacity includes one or more unused spectral channels.

As an alternative or in addition time-domain-multiplexing of the C-OTDR function with a telecommunication function in the same spectral channel may be employed. The C-OTDR may be spectrally overlapped with telecommunication channels by synchronising when the optical field (for the C-OTDR function this could be both discrete pulses or continuous optical fields in spread spectrum modulation techniques) sent or associated with the C-OTDR function and when it was associated with the telecommunication function.

The one or more unused spectral channels may include wavelengths outside the wavelength range used in the optical fibres for communications purposes. For example, if all optical fibres in the fibre-optic bundle are lit, and the communications wavelengths in the optical fibres span the C band (between approximately 1530 nm and approximately 1563 nm) and the L band (between approximately 1575 nm and approximately 1610 nm) for communications purposes, one or more unused wavelengths at outside the C band or the L band may be utilised for obtaining surveillance information according to the present disclosure. The particular selection of the one or more unused wavelengths may be based on the gain spectrum of any existing erbium-doped fibre amplifiers (EDFAs) deployed in the communications network for extending its reach. Where existing EDFAs are deployed, selecting the one or more unused wavelengths from discrete wavelengths at 1525 nm, 1569 nm and 1615 nm (i.e. just outside the C and L bands) enables amplification without the need for additional EDFAs to extend the reach of interrogation signals. In another arrangement, the network may include a dedicated network for acoustic sensing purposes, operating in conjunction with an established network for fibre-optic communications, to extend the reach of acoustic sensing. A major advantage of using an existing communications network is that no dedicated cables have to be deployed at an additional and very significant cost, or that only minimal additional dedicated lengths of routed cable are required.

The optical fibres are distributed across the geographical area to substantially cover the geographical area, in contrast to optical fibre deployment along a perimeter of the geographical area (e.g. surrounding a secure building or campus) or deployment covering in a substantially linear or elongate space (e.g. along a long gas or oil pipe).

The distribution may be substantially even to cover the geographical area. Alternatively, the distribution may be denser to cover some portion(s) of the geographical area in higher spatial resolution than others, which is typically the case in inner city/urban areas, or other areas with high fibre optic coverage, as a result of the NBN network in Australia for example.

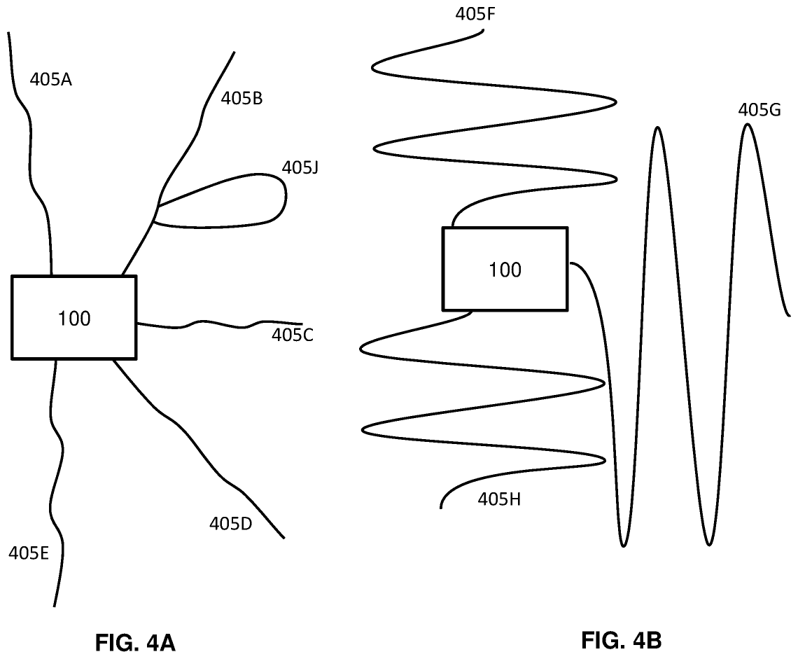

In one arrangement, as illustrated in FIG. 4A, the distribution includes optical fibres (405A to 405E) fanning out from one or more centralised locations (e.g. at a data centre 100 having a switch (not shown) to time-multiplex interrogating pulses into the optical fibres (405A to 405E)). Each fanned out optical fibre can extend into two or more optical fibres to increase spatial resolution as the optical fibres fan further out. Alternatively or additionally, as illustrated in FIG. 4B, the optical fibres (405F to 405H) can be installed with zig-zag patterns to provide spatial resolution with fewer but longer optical fibres. In general, the disclosed system and method is expected to achieve about 10 metre resolution or better. This can be achieved by virtue of an existing fibre infrastructure covering most major roads in a city in a first deployment step. As a second step fibre will be deployed at a more granular level over most streets and roads in a city so as to achieve comprehensive coverage in the form of a 2D grid, again with acoustic channels every 10 m on every street and road. In many cases this would not be necessary thanks to the density and ubiquity of installed fibre infrastructure, which would typically be in the form of an existing public telecommunications network. This will in most cases include fibre that extends across most if not all public thoroughfares in an urban environment, including road and rail networks.

The applicant is aware for example that there is dark fibre on all the existing main and even subsidiary roads in Sydney, Australia. The applicant is also aware that a large fraction of the streets also have fibre with the roll out of the Australian NBN and other existing FTTH FTTN deployments. These can be usefully deployed in the present embodiment.

In one arrangement, the optical fibres may include those installed underground, in which case the coverage of the geographical area includes the street level of a city, which is useful in monitoring vehicle and pedestrian traffic. Alternatively or additionally, the optical fibres may be installed within a multi-storey building (e.g. an office building or a shopping mall or a multi-level parking lot), in which case the alternative or additional coverage of the geographical area is the multiple floors of the building, which is useful in monitoring staff or shopper movements.

Aerial optical fibres may also be deployed like power lines or across harbours or other bodies of water. In addition or alternatively submarine fibres may be used for shipping, marine life, or environmental monitoring and the like. A dedicated fibre section may be spliced in to the existing optical fibre network on which the network is already deployed—e.g. a dedicated optical fibre cable could be routed around the Australia's Sydney harbour bridge at points of interest and then the two ends of the section of dedicated fibre is spliced in to the existing optical fibre network as is shown schematically at 405J for convenient remote access by a node located at for example a remote data centre. The system 100 may include a communications interface 117 (e.g. wireless or wired) to receive a search request from one or more remote mobile or fixed terminals 117A, 117B and 117C. Upon receiving a search request, the processing unit 114 may be configured to determine the requested information based on the stored electronic data, including those stored in the volatile and/or non-volatile memory. The requested information is on one or more of: (a) one or more of the multiple targets (i.e. the “what” or “who”), (b) one or more of the multiple instants (i.e. the “when”), and (c) one or more of the approximate locations (the “where”). Where the search request relates to specific targets (e.g. particular pedestrians or vehicles in a suburb), the determined information for return may include where and when each of them is/was, based on the stored electronic data. Where the search request relates to specific times (e.g. between 8 am and 9 am on Jan. 1, 2016), the determined information for return may include what targets and where they are/were. Where the requested information relates to specific locations (e.g. locations surrounding a crime scene or accident scene), the determined information for return may include what and/or who were nearby the crime scene or accident scene and when they were there. A skilled person would appreciate that the requested information may be on a combination of “what”, “who”, “when” and “where”. Some non-limiting examples are provided below.

In the case where the geographical area includes the street level of a city, a search request may be for the number of vehicles between 8am and 9am within a particular area spanning 10 blocks by 10 blocks, corresponding to an intersecting grid of optical fibres. In this case, the requested information may be determined by the processing unit 114 by retrieving the electronic data recorded at the multiple instants between 8 am and 9 am associated with detected acoustic disturbance signals at fibre distances corresponding to the approximate locations in the particular area. The retrieved electronic data may be processed to generate acoustic disturbance signals.

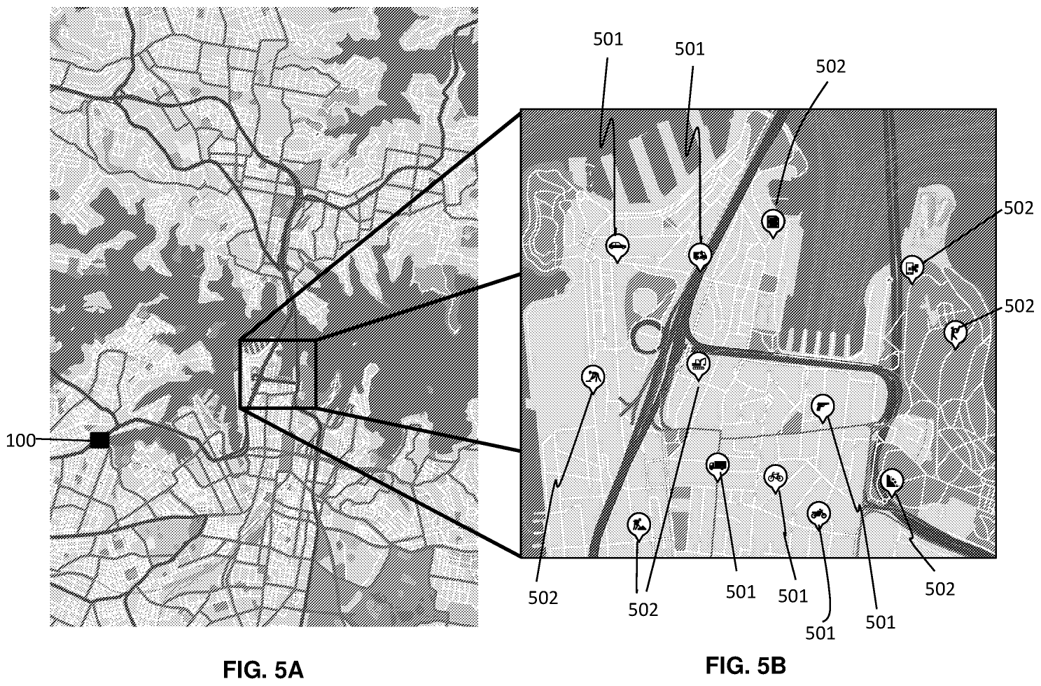

The FIR or other correlation filter types generate a digital detection event of a sound object (in the same way that an analog signal is converted into a digital representation of 1 and 0's depending on the signal amplitude at the sample time. The system generates digital symbols from processed acoustic signals that represent objects (with properties) in cities such as cars, pedestrians, trucks, excavators and events such as car crashes, gun shots, explosions, break-ins etc.). This may be incorporated on a GIS overlay, with digital symbols overlaid on the map, as is clear from FIG. 5B, which includes pedestrian and car symbols.

Once the system has a digital record of these symbols it is possible to put together a very efficient index (in terms of time to search it and in terms of data size to hold the real time and historical indices) of object symbols that can be searched in the same way that any data base is presently searched on a computer. This search function will operate at the level of symbols, i.e. will not use raw acoustic information in standard operation other than circumstances where a higher fidelity of symbols may be required (for example—one symbol index may just be made up of cars and trucks in a given city and what is subsequently required is a further 3 different categories of trucks (i.e. 18 wheelers, medium trucks, light trucks) and cars (Large, medium and small) in which case some re-processing may be required of the raw acoustic information (with more specifically tuned correlation filters) to generate the higher fidelity symbol index, in cases where an additional higher fidelity index has not yet been generated for the particular geographic area and time.

FIG. 2C shows the steps involved in receiving the search request at 220, searching the symbol index databases at 222 and at 224 correlating the symbol index databases with non-acoustic data, returning search information 225 so as to provide an enriched dataset.

FIG. 2D shows the additional retrieval steps involved in mining historic data at 222 by retrieving raw acoustic and/or optical data from the cloud 215A at step 222A, processing the raw acoustic/optical data at step 222B, which in the case of the optical data would include demodulating it at the optimum sampling frequency, and at step 222C applying acoustic signature-based filters to the acoustic and/or processed optical data to detect historic sound objects or events. At step 222D the process reverts to step 224 of FIG. 2C or alternatively or subsequently to step 210 of FIG. 2A.

With the grid of fibre paths and substantially overlapping sensing range described in this disclosure, multiple phased array beams may be formed with subsets of sensor channels from the total sensor array formed over the length of optical fibre interrogates. This plurality of beams may have different spatial positions (i.e. which subset of sensors from the total sensor array are selected corresponding to a different geographical location in the system), angular orientation (which angle or angles relative to the local length axis of the fibre) and/or directivity (aspect ratio of the sensing beams—i.e. how sharp or obtuse are the beam spatial shapes) properties around the system to achieve higher level sensing functions in the system that include long range detection, localisation, classification and tracking of acoustic sources in a 2D or 3D coordinate system.

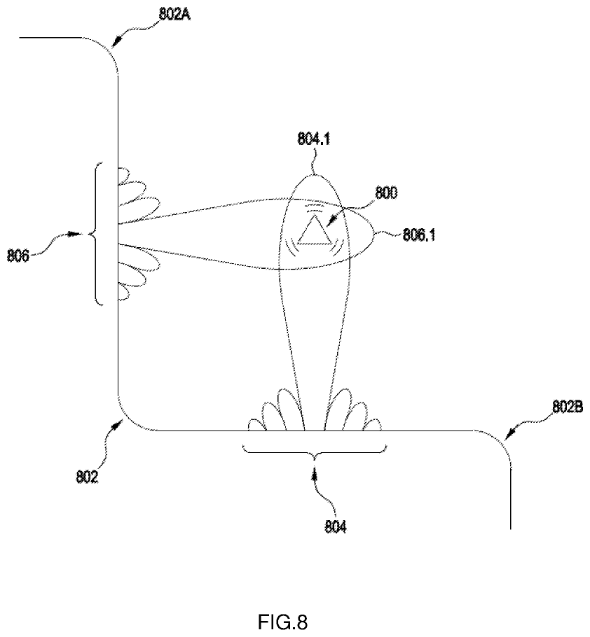

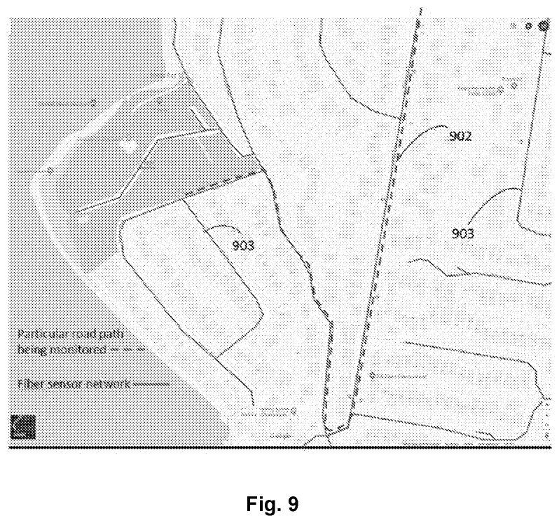

By way of example, FIGS. 2E and 8 illustrate how a stored optical data may be effectively used to generate phased array sensing beams to locate a target/sound source 800 which is spaced from a fibre optic cable 802.

At step 226 a search request is received for surveillance data. This could be based on a previous incident identified through internal acoustic (via a symbol index for example) or external non-acoustic detection means or could alternatively be based on a need to dynamically monitor a particular area. At step 228 stored raw optical data is retrieved from cloud storage using time and location filters. The retrieved data is then processed at a desired resolution for beam forming, as is shown at 230. In the particular example the an acoustic time series could be generated between points 802A and 802B with a resolution of 1 m, which would allow for generation of phased arrays at 804 and 806 and consequent generation of phased array sensing beams having major lobes 804.1 and 806.1 which overlap to detect the location of the acoustic source 800, as is shown at step 232. The beams may be tuned by the phased array to scan the area around the target, in both 2D and 3D.

In this way relevant segments of the stored optical data may be extracted and processed in a targeted way, covering areas of interest or those requiring additional coverage by virtue of their location away from the installed fibre optic cable.

In another case, a search request may be used to determine where bus passengers alighting from a particular bus arriving 8:05:55 am on a particular day at a particular bus interchange walk to. In this case, the requested information may be determined by the processing unit 114 retrieving the electronic data recorded at the multiple instants from 8:05:55 am onwards and continued for 30 minutes and associated with detected acoustic disturbance signals detected at fibre distances corresponding to a 1 km radius from the bus interchange. The electronic data could be raw data but would preferably be in this case the symbol indices associated with pedestrian activity at the relevant time and location.

A fairly broad pedestrian detection filter may be applied to efficiently locate all pedestrians within an area and then a much more specific set of filters could be applied to classify footwear type (sole type—rubber, leather, metal), gait of walk by ratio'ing number of steps for given distance along a path to estimate height of person, speed of walk, estimated weight of person from low frequency pressure amplitudes generated by footsteps on pavement, as well as entry and exit or start and finish points if within the area. As previously noted these filters are generally initially applied to the acoustic data at the time of collection, so as to enable the storage of symbols representative of object and activity type, though for higher resolution raw acoustic or optical data may be retrieved and reprocessed.

Tracking algorithms, once initiated on objects that move fairly consistently (i.e. pedestrians and road vehicles for example, as opposed say to excavators which do not move consistently or predictably) look at where particular footsteps are detected and any history of them and set location and velocity filters to follow a track by assuming their walking speed is going to remain relatively consistent. The algorithms are also able to allow live tracking of vehicles or pedestrians, including entry/start and exit/finish points. These tracking algorithms allow the system to build up a more comprehensive set of properties for an object and/or for multiple objects by following (accumulating a longer time series and bigger data set) the object(s) across a number of stationary but virtual acoustic channels. For example, a tracker set on a car can build up a continuous speed profile of the vehicle over many kilometres (across hundreds of individual acoustic channels in the system), it can also apply more comprehensive frequency and time domain analysis to determine what elemental sound objects are present within the overall object, for example with a car, there are included sound objects such as tyres on the road, a rotating combustion engine, its speed of rotation (from idling upwards), a transmission system, brakes, stereos, horns, and cooling fans. If the sound data coming from the engine, including variations in sound from rpm, is isolated this could be further analysed this for features like number of cylinders from the firing sequence (straight 4, straight 6, V6, V8, V10, V12—all of which have a distinctive sound sequence, with the exhaust note in addition being distinctive across the engine model).

In yet another case, a search request may be initiated to identify any foot traffic or vehicle movements nearby a jewellery shop that has had an overnight theft at an unknown time during non-opening hours. In this case, the requested information may be determined by the processing unit 114 retrieving the electronic data recorded after the shop closed the previous night and before the shop opened the next day at a fixed radius (e.g. 5-10 km) from the shop. This may be further refined if there was an acoustic record of the break-in event which was time stamped and identified through its acoustic signature. This could then be correlated with similar time-stamped pedestrian or vehicle activity which could then be tracked and potentially identified as set out below.

The electronic data could be raw data but would preferably in this case be the symbol indices associated with pedestrian activity at the relevant time and location. In the case of raw data, to accentuate the presence of acoustic disturbances in the signals relating to pedestrian traffic (such as those caused by footsteps going into and leaving the shop) a particular FIR filter may be used to enhance the frequency components associated with footsteps (e.g. 2-10 Hz), initially focussing only at the shop location. The processing unit 114 is then configured to track any footsteps leaving the shops to where the footsteps end. This could also be achieved by searching the pedestrian symbol index for the time and location from which pedestrian tracking information could be generated. To anticipate the possibility of the thief getting away in a vehicle, the processing unit 114 may be configured to then track any subsequent vehicle movements originating from where those footsteps are tracked to, or by searching the vehicle symbol index and correlating this with the pedestrian index to identify potential crossover locations where pedestrian activity morphed to vehicle activity, from where one of more particular vehicles may be tracked to a termination point. Vehicle ID could also be determined through non-acoustic means such as cameras under the control of third parties and correlated through time stamping with DAS signals. The determined location may form a lead, such as where the stolen goods and the thief might have been or may still be, for law enforcement personnel to further investigate. The recorded data may also be used for forensic and evidentiary purposes when investigating crime and crash sites for example, and identifying and monitoring the movements of potential perpetrators and witnesses. This may in turn be used to reconstruct crime and accident scenes and to generate crime and accident scene reports. In order to comply with privacy legislation in the generation of such reports third party non-acoustic data is utilised rather than that data being sourced by the same party that sources the acoustic data.

In another arrangement, the step of processing signals representing the acoustic disturbance into symbols may be based on artificial intelligence and machine learning. In this case Al has the ability to discern a far greater number of distinct sound objects (ie car detections in symbols that represent distinct make and model) as well as the ability to pull out sound objects from very faint acoustic signatures amongst high noise backgrounds. This will expand the range over which the fibre optic cable can hear certain object classes and sub-classes and increase the detection rates of all objects around the cable. It will also decrease the false alarm rates as many more logic parameters can be brought to bear before making a sound object detection and classification decision. Al is accordingly applicable in particular to expanding the symbol set that can be detected for sound objects on roads, for example, where multiple vehicle classes and sub-classes are present, as well as events associated with different acoustic events such as excavations, car crashes, gunshots, explosions, and glass pane breakages or percussive or hammering sounds associated with break-ins.

A key part of the machine learning and Al function is a mechanism to record an acoustic signature associated with a particular sound object classification and have a feedback mechanism for the system to 1) link a symbol/object type (i.e. make and model of a car) with that sound signature detection. This could be done manually with an operator looking at a video monitor of a given road way or with machine vision applied to a singular or otherwise small number of locations on a road way. An iterative training sequence may also be employed where the detection and classification of objects is fed back as correct or incorrect based on other means of detecting the objects (i.e. video and machine vision). This feedback is key to developing high fidelity discernment and low false alarms, and could be implanted in a live in situ environment with for example the operation of a CCTV camera/video monitor in conjunction with DAS to record and identify sound objects and events. FIG. 2B shows how step 210 in FIG. 2A can include a number of training sub-steps in which sound objects and events that have been classified at 210.1 are compared with object/event images at 210.2. At 210.3 if the comparison is correct the resultant correctly classified symbol is stored in the digital symbol index database at 210.4. If not the classification process is repeated until the image of the object/event and the sound image/event match.

In addition to a CCTV or CAV network a network of Bluetooth detectors may also be used to pick up MAC addresses of the mobile devices of pedestrians/motorists and based on the correlation between the pedestrian/motorist and the mobile device can constitute an additional means of assisting in object classification, and identification, in particular in security applications or when monitoring for criminal activities. The activities of a motorist who exits a vehicle to become a pedestrian, and vice versa, may also be tracked in this way, at the same time identifying and recording any characteristic acoustic signature so tracking can continue when other non-acoustic sensors (CAV, Bluetooth) are not operating.

For example in certain situations where CAV is pervasive in an urban area, in the form of regularly spaced CCTV cameras and the like, these may be used to correlate/stitch together images of individuals and vehicles to track and identify them in this distributed CAV environment. When used in conjunction with DAS this is more effective as coverage may be extended to those areas which have no line of sight coverage. This is further enhanced when data from other sources such as 4G, Bluetooth, and GPS is fused.

The effectiveness of DAS is further enhanced, especially in environments where other sensing networks are not as pervasive or responsive, if it has the ability to obtain acoustic signatures capable not only of distinguishing vehicle make and model but also individual vehicles say of the same model but with different acoustic characteristics as a result of tyres, tyre wear, engine vibrations, audio systems and the like so that a vehicle can be identified and tracked on the basis of its unique acoustic signature alone, or for long periods without having to validate with other sensors/signals. The same could apply to pedestrians who could be distinguished based on footwear, gait, etc., as has been mentioned above.

FIG. 1 shows how an existing CCTV network represented by cameras 118A, 118B and 118C linked to a monitoring centre 119 may be used in the training steps above, with the digital video data or at least the video classification data being transmitted back to the processing unit 114.

FIGS. 5A and 5B illustrate distribution geometry of the acoustic system in with a Google® maps GIS overlay of part of Sydney. A fibre optic network comprises the existing fibre optic network which extends across the Sydney area, from data centre 100. As described above, the network extends across main, arterial roads indicated in dark outline and other roads indicated in light outline, to obtain widespread coverage of the city area.

FIG. 5B shows typical graphical representations of a typical monitor at any moment in time including representations of sound object symbols 501 and activity-based symbols 502, which are self-explanatory. The symbols may be moving or stationary.

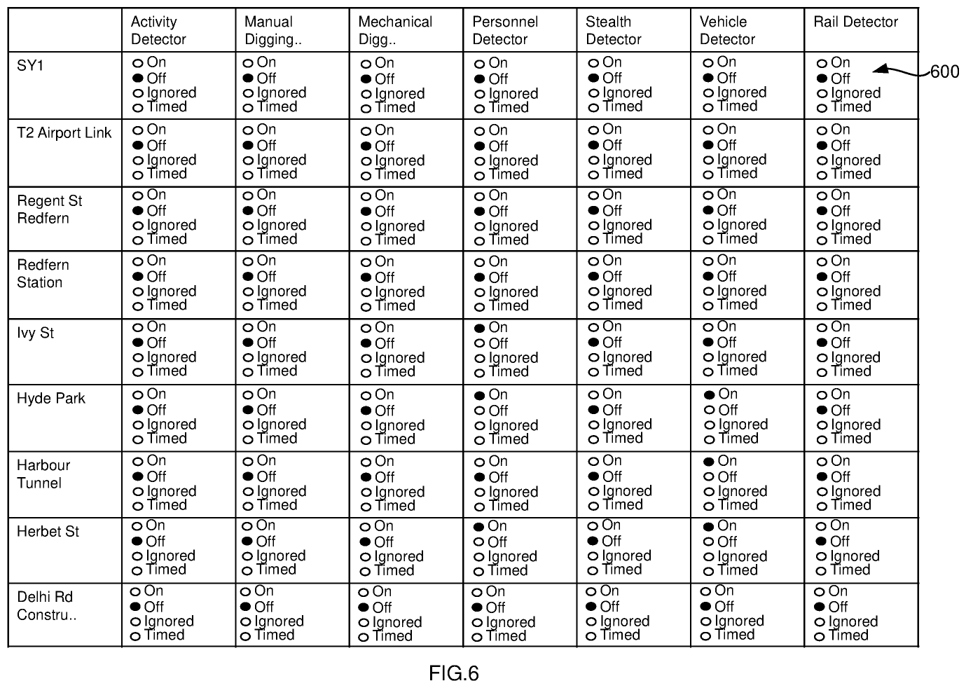

Referring now to FIG. 6, a typical subscriber interface 600 is shown which allows subscribers to select location and symbol parameters for of interest to them for monitoring purposes. For example the locations of Ivy St, Hyde Park and Herbert St have been selected for personnel and vehicle detection, and the Harbour Tunnel has been selected for Vehicle detection by turning on the relevant radio button icon. This selection may be by one or multiple subscribers, and it will be appreciated that many other activities and locations may be selected, as well as time periods as described above.

A skilled person would appreciate that, rather than storing and then retrieving the electronic data, the electronic data once ready to be stored can be used without retrieval for real-time monitoring as explained in the examples above. A search request associated with real-time monitoring may be to provide the number of walking pedestrians in real-time. In this case, the processing unit 114 may be configured to discern individual persons by footsteps and count the number of discernible people at short and regular intervals (e.g. every 5 seconds). Alternatively, a skilled person would also appreciate that, rather than storing electronic data relating to the raw acoustic disturbances for later retrieval, the disclosed method may store the processed acoustic disturbance signals for later retrieval. In this case, the requested surveillance data includes determining the requested surveillance data based on the processed acoustic disturbance signals.

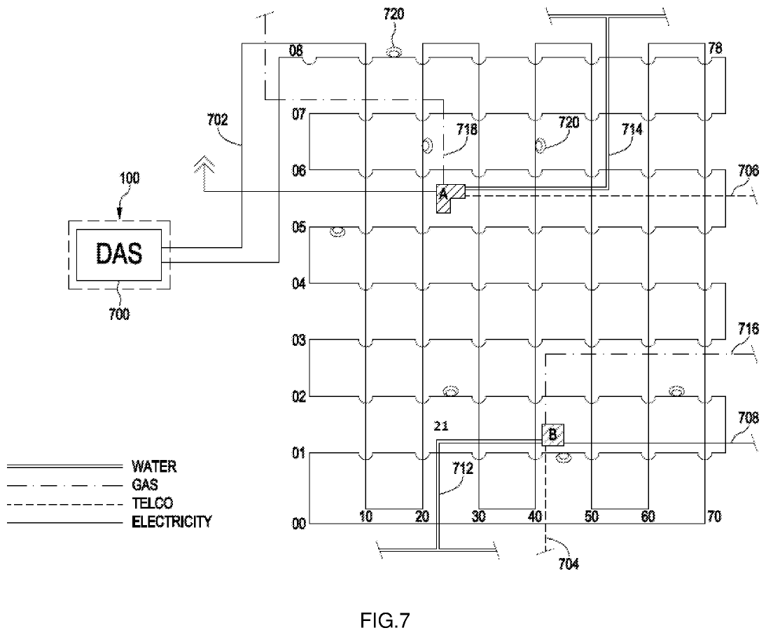

Referring now to FIG. 7 a distribution geometry shows how virtual paths may be created from an existing optical fibre network for servicing individual subscribers in a geographic area. Subscribers are associated with respective buildings A and B in an urban environment. The environment includes a data centre 100 including a DAS system 700 of the type described in FIG. 1. An existing fibre optic cable network in the form of a single fibre optic cable 702 extends from the DAS system 700 and covers an entire city centre. In the example the fibre runs first vertically and then horizontally in a serpentine fashion across a grid defined by a road network. It will be appreciated that in reality the grid will be far more irregular but that this is still a representation of the extent of coverage that can be provided by an existing fibre optic cable of this type in city centres such as Sydney and New York.

Each installation or building A and B has a critical infrastructure footprint that requires monitoring and protecting including telecoms lines 704 and 706, power lines 708 and 710, water mains 712 and 714, and gas lines 716 and 718. Each of these generally follows segments of the fibre optic cable. For example the water mains line of building B extends from co-ordinates 20 to 21 and 21 to 41, and telco line extends from co-ordinates 40 to 41. As a result, for each of the subscribers associated with buildings A and B, virtual sensing lines are created made up of selected segments of the fibre optic cable, and only these segments require monitoring for each subscriber. An advantage of using virtual paths crated from actual segments of an existing fibre optic cable is that numerous buildings can be simultaneously and monitored in both real time and using historic data for subscribers in an urban environment using an existing fibre optic network. It will be appreciated that the fibre optic network may be made up of a number of different fibre optic cables in which case segments from different cables may be “stitched” together to create a number of virtual dedicated sensing and monitoring networks for each of a number of entities in a typically urban environment where there is a high density of installed fibre optic cable.

This can be achieved in a number of ways. Once a determination is made of which fibre segments are of relevance for a particular subscriber, the geographic coordinates associated with the segments are stored and then correlated with the generated datasets so that they may be selectively monitored.

It is also possible to retrieve historic data which has been time and location stamped and to process this in the same manner. As was described with reference to FIG. 6 the subscriber could also select location, time and symbol parameters of interest.

As can be seen at 720, the fibre optic cable is typically formed with spools or loops to provide flexibility for splicing or repairs. Spatial calibration is accordingly required as an initial step so that there is correlation between the detected fluctuations in the cable to the geographic location of the cable. This process is described in more detail in the specification of International patent application PCT/AU2017/050985 filed on 8 Sep. 2017 in the name of the applicant entitled “Method and system for distributed acoustic sensing”, the contents of which are incorporated herein in their entirety by reference. It will be appreciated from the specification that acoustic, spatial and physical calibration are generally required.

The presently disclosed system and method of distributed acoustic sensing may be used with phased array processing and beam forming techniques. As mentioned above, outgoing light 106 may be sent into the fibre-optic sensing cable 205 as a series of optical pulses. The reflected light 210 produced as a result of backscattering of the outgoing light 106 along the fibre-optic sensing cable 205 is recorded against time at the receiver 208. This configuration permits determination of an acoustic signal (amplitude, frequency and phase) at every distance along the fibre-optic sensing cable 205. In one embodiment, the receiver 208 records the arrival times of the pulses of reflected light 210 in order to determine the location and therefore the channel where the reflected light was generated along the fibre-optic sensing cable 205. This phased array processing may permit improved signal-to-noise ratios in order to obtain improved detection of an acoustic source, as well as the properties of the acoustic source.

Further, from the above examples, a skilled person would appreciate that, rather than storing or basing the determined data on the raw or processed optical or acoustic disturbance data, the method can classify the acoustic data into different types of acoustic data, in the form of symbols. The method can subsequently store and determine the requested data based on the classified acoustic data. The different types of acoustic data can each be associated with a corresponding target type. For example, the classification involves classifying targets based on the processed acoustic disturbance signals for storage as symbols and for later retrieval to form the basis of determining the requested data. In one arrangement, the processing unit 114 may be configured to classify acoustic disturbance signals into one of more target types.

Classification may involve applying a corresponding FIR filter for each target type. For example, classification includes applying an FIR filter to detect tyre noise to facilitate classifying acoustic disturbance signals as a moving vehicle. Another FIR filter may be used to distinguish between a car and a truck. As another example, classification includes applying a FIR filter to detect footsteps to facilitate classifying acoustic disturbance signals as a walking pedestrian. As yet another example, classification includes applying a FIR filter to detect rail track noise to facilitate classifying acoustic disturbance signals as a moving train. Each classified target may then be pre-tracked, before a search request is received, by processing unit 114 and stored in storage means 115 or 115A for later retrieval.

In one arrangement, the electronic data may be data-mined in real time to generate alerts (such as real-time alerts or daily alerts) of requested information based on a search request.

Referring now to FIG. 9 a selected portion of a fibre optic network in northern Sydney, Australia, is shown as a Google® Maps overlay with a 1.5 km sub-street path segment 902 marked in broken outline of an existing fibre optic cable forming part of an established network 903, and showing optical path distances relative to a shoreline or beach.

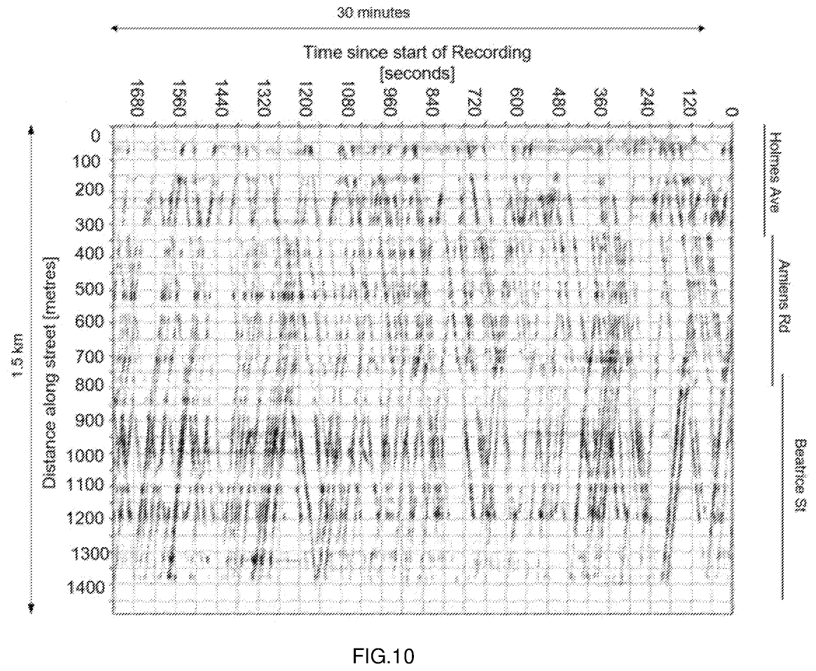

FIG. 10 shows a plot of vehicle tracks detected, identified and recorded over a 30-minute period against distance along the street overlying the fibre optic segment by processing the filtered acoustic data over that period, as per step 234 of FIG. 2F. Optical distance is accurately mapped and correlated with the physical location of the optical fibre and geographical coordinates which may include street addresses. This process of correlation is described in more detail in the complete specification of incorporated International patent application PCT/AU2017/050985.

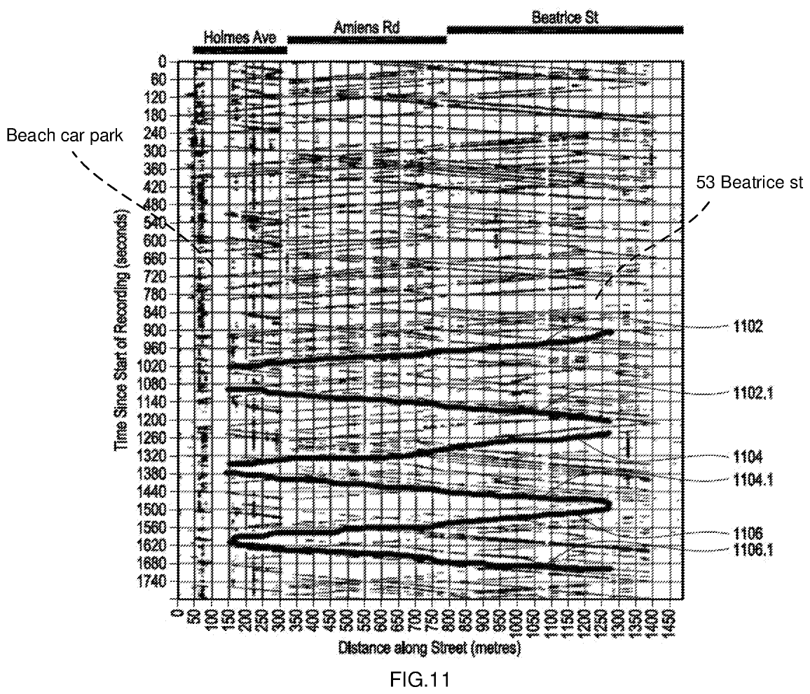

Tracks made by the same vehicle are identified and correlated at step 236, and are also highlighted in FIG. 11 which shows return journeys on three occasions from 53 Beatrice St to the Beach Car Park and back at 1102, 1102.1, 1104, 1104.1 and 1106, 1106.1. The identification and correlation may be made based on one or more characteristics of the tracks, as per step 236, including starting point and end point, as well as the acoustic signature of the particular vehicle. The correlated tracks are then analysed at step 238 to extract trends or behavioural characteristics including start and end times and locations, number of trips to specific locations, driving behaviours and the like.

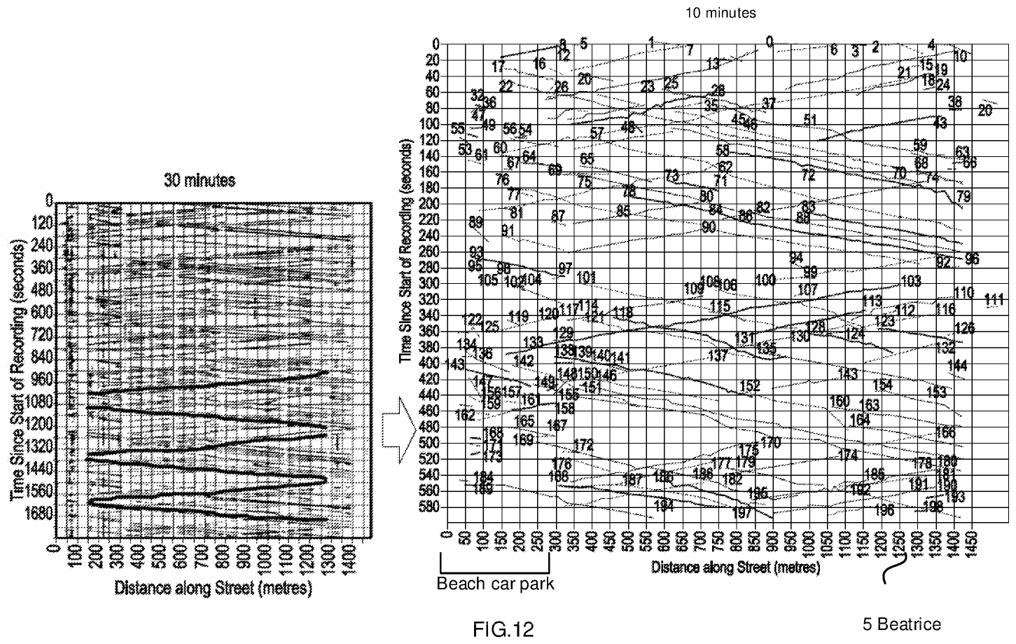

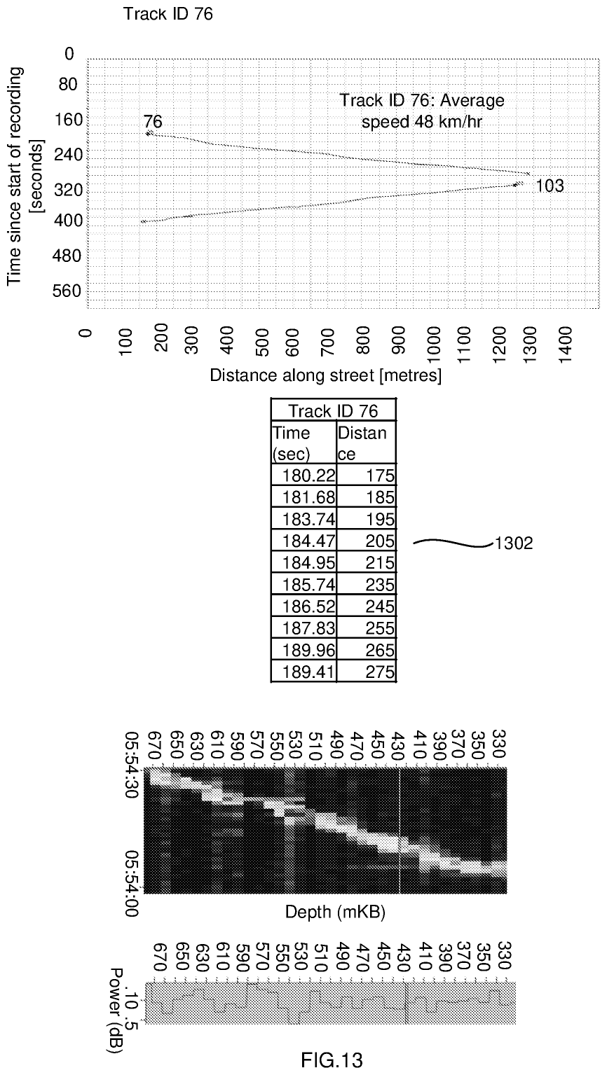

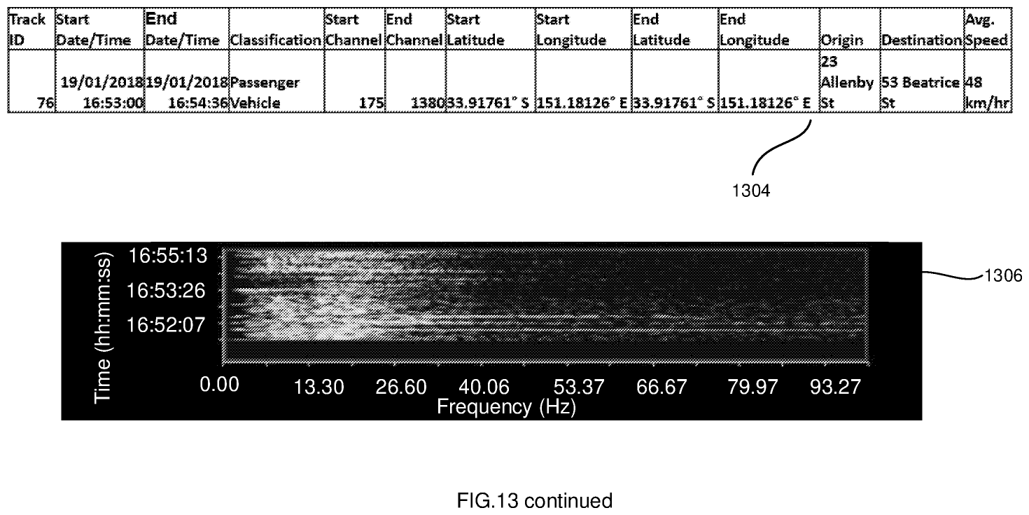

As is shown in FIG. 12, each of the vehicle tracks is tagged with unique track identification number, with successive numbers corresponding to an increase in lapsed time. FIG. 13 shows a more in depth analysis of vehicle track ID 76. Time to the nearest 0.01 s is recorded at table 1302 for 10 m distance intervals and the average vehicle speed is then calculated at 48 km/h. Table 1304 provides further detail of Track ID 76, including start and end times, vehicle classification, start and end channels, start and end latitudes and longitudes, origin and destination addresses and average speed.

Every channel or position contains substantial rich acoustic information about acoustic objects at or passing that position, as can be seen at 1306 from the acoustic frequency spectrum of channel 54 ranging between 0 Hz and 100 Hz over a period of less than 4 minutes. The example shown in 1306 illustrates that power of frequencies approximately ranging from 16 Hz to 23 Hz is relatively higher than other frequency bands, which indicate a specific vibration signature of the vehicle being observed.

Identification of individual vehicles may be via a number of means, including Bluetooth sensors for identifying the MAC addresses of Bluetooth or WiFi-enabled vehicles, as well as video cameras 118A forming part of CCTV networks or the like for identifying vehicle registration plates, and using computer aided vision, also known as ANPR (automatic number plate recognition) cameras.

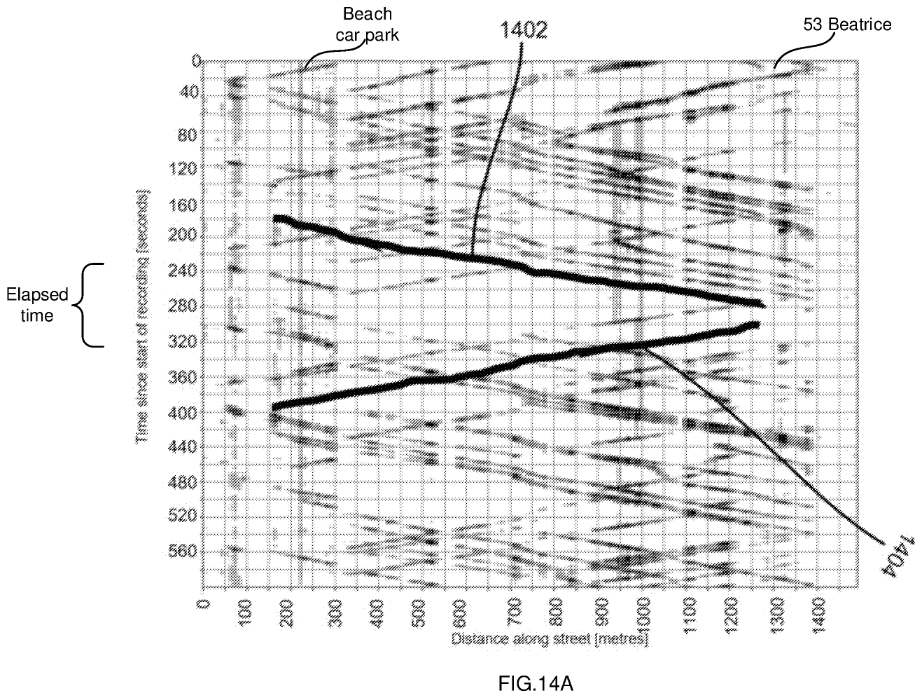

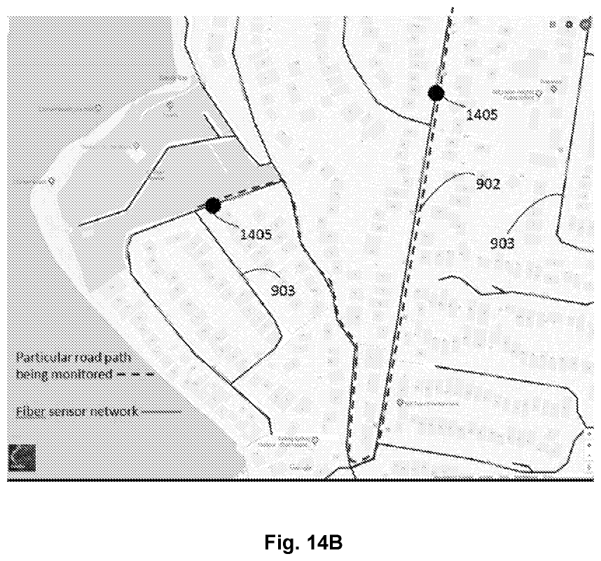

Referring now to FIGS. 14A and 14B, a return trip between 53 Beatrice St and the beach is shown as being tracked by highlighted traces 1402 and 1404 in FIG. 14A, the start and end points being indicated at 1405 on the map of FIG. 14B. In addition, individuals within the vehicle may also be identified via their mobile phone MAC address. The vehicle type and registration (e.g. Lexus RS, Reg: 123-RAJ) may also have been identified using one or more video/ANPR cameras or a look-up table correlating the MAC address(es) of the individual(s) within the vehicle with its other details.

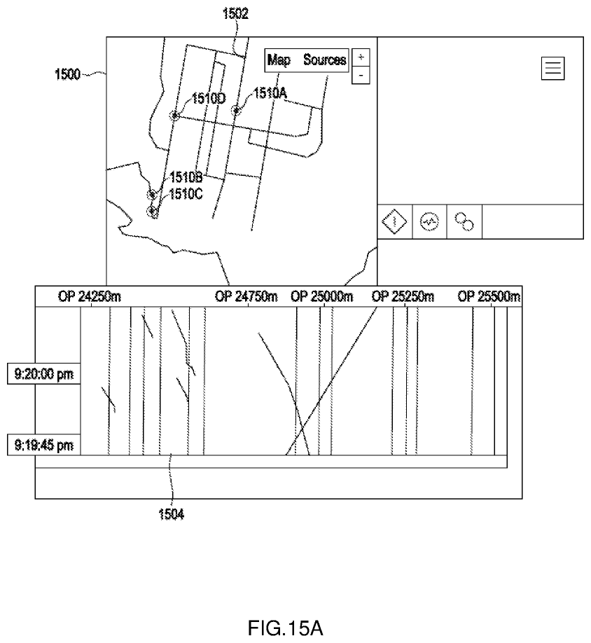

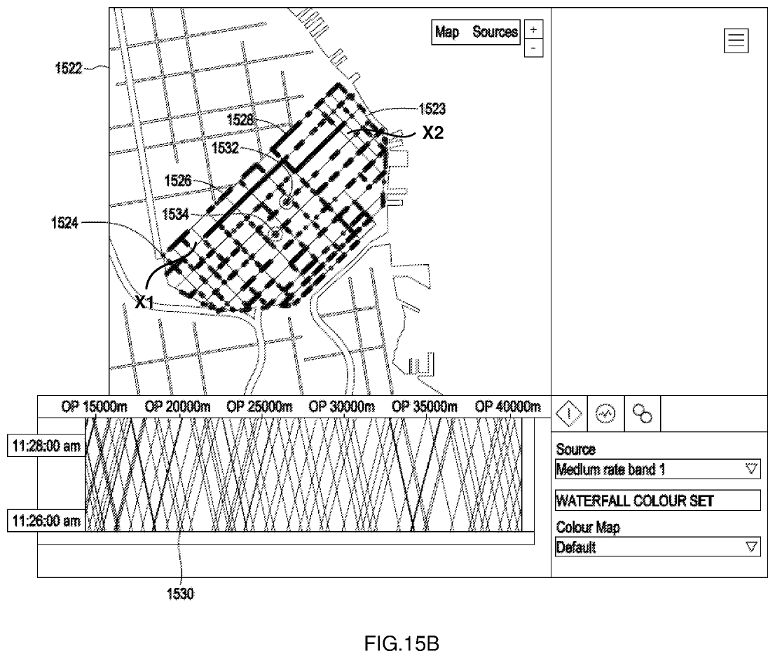

Referring now to FIG. 15A, a frame of a live map portion 1500 illustrates a linear path 1502 in Sydney employing real-time object tracking and detection. Moving vehicles denoted as symbols 1510A, 1510B, 1510C and 1510D are detected, identified and dynamically tracked as shown on the live map portion. Other types of objects, such as pedestrians, may also be detected, identified and dynamically tracked as shown on the live map portion via their speed profiles and signal step profile and the MAC address of their mobile handsets may be used as a proxy. Correspondingly, trace diagram 1504 shows a plot of vehicle tracks detected, identified and recorded over a 15 second period against distance along the path overlying the fibre optic segment by processing the filtered acoustic data over that period, as per step 234 of FIG. 2F.

Referring now to FIG. 15B, a frame of a live map portion 1522 further dynamically illustrates a denser urban area (in this case downtown San Francisco) using simulated real-time data of vehicles on a 2D grid defined by a fibre optic segment or array of segments 1523. Different shades of the dots 1524, 1526 and 1528 on the 2D grid denote different types of moving vehicles. Vehicle start and end points may also be identified and stored, one example of which is shown at X1 and X2. Corresponding vehicle tracks are illustrated in 1530 over a 2-minute period against distance along the path overlaying the fibre optic segment 1523 by processing the filtered acoustic data over that period, as per step 234 of FIG. 2F.

It is anticipated that latencies of as little as 100-300 ms are achievable so that drivers are able to dynamically monitor traffic conditions, including those which are not in line of sight, with up-to-date information. The live map portion may form part of a vehicle screen display for navigational purposes, and includes the vehicle being driven 1532. In addition, driving patterns are monitored in the manner previously described so that vehicles being driven erratically or in excess of the speed limit are identified on the screen so that the driver may be forewarned to steer clear of them, as is shown at 1534. This information may also be used by law and traffic enforcement agencies, both in real time mode and for later retrieval and analysis. Pedestrian activity may also be plotted, so that pedestrians are able to identify and monitor pedestrian movements and conditions, including areas of crowding/congestion.

If Bluetooth sensors alone were used for tracking Bluetooth enabled vehicles or pedestrians carrying mobile devices they would need to be placed relatively closely apart for the vehicle's route to be properly identified through their MAC addresses. However when integrated with DAS, vehicles and/or pedestrians can be accurately tracked and identification of the vehicle/pedestrian can take place at far less regular intervals. The same would apply in the case of video camera systems. Driving patterns and behaviours can also be identified and analysed without the need to resort to a dedicated wireless network.

All of the above noted information is stored in a database for retrieval and analysis by a semantic engine. In particular information associated with a particular vehicle is stored against its MAC (if applicable) or registration No. This then allows analysis of behavioural trends not only during one trip but based on multiple trips, including locations visited, regularity of such visits, visiting times, dwell times, driving patterns, and the like. Over time behavioural patterns can be detected based on the identity of the driver, using if need be the MAC address of a mobile device associated with the driver.

The resultant dataset can also be integrated using a data fusion engine with other non-acoustic sources of data, including GPS data, data from mobile networks, stationary sensors and social media data from location based social networks (LBSNs). The fused data can then be analysed using machine learning to further identify trends and behavioural characteristics.

By monitoring individual vehicles over a period of time, datasets relating to individual vehicle behaviour as well as collective behaviour may be built up for numerous applications including improving transportation network performance, traffic management, incident detection and prevention, crime prediction, adaptive traffic control, including ITS applications and their optimisation, and security applications. Other objects including pedestrians and cyclists may be monitored and the transport network may be optimised to accommodate them as well. Further, individual monitoring may also result in the ability to provide bespoke services and solutions on an individual basis depending on behaviours.

The disclosed method and system allows for almost ubiquitous coverage of objects and events in high density environments where there are established fibre optic networks, generating data for use in real time as well as for storage and analysis. The sheer volume and accuracy of data generated makes it highly amenable to machine learning, before or after fusion with other data sources, to predict trends and behaviours across groups and individuals, and thereby to increase security, and to optimise various other processes.

Monitoring of acoustic events allows for alerts to be generated for the prevention or identification of various incidents, or for localising (to a latitude and longitude position) and tracking of road users in the case of pedestrian and road traffic. With fibre paths that are calibrated with time of flight and position of the fibre in an area, a distributed acoustic sensing system can locate and track sound objects (i.e. vehicles) and sound events (i.e. explosion) in the same way a GPS receiver is widely used today but with one important difference, distributed acoustic sensor arrays do not require any navigation equipment to be present on the objects or events being sensed. Thus, distributed acoustic sensor networks are able to sense substantially all sound objects or events from a third party perspective.

It should be apparent to the skilled person in the art that the described arrangements have the following advantages compared to non-acoustic sensing:
Compared to a static image capturing system (e.g. street views captured by moving cameras), the disclosed arrangements can be used for real-time monitoring as well as for searching for past events and at multiple instants in the past using various search filters and predictive monitoring.
Compared to sensors on a large number of mobile devices (e.g. means which depends on presence and operation of user devices, which are not tied to a particular object), the disclosed arrangements rely on a third party observation system in the form of a fibre-optic infrastructure which is network-agnostic, is relatively static and reliable, can be used to reliably classify objects and events, and is in many environments ubiquitous).
Compared to lower coverage and significantly more expensive camera techniques, (e.g. CCTV-based surveillance camera having a depth of view of tens to hundreds of metres), the disclosed arrangements require a single optical fibre to gather surveillance with a reach of tens of kilometres (up to at least 50 km and 1,000's of individual acoustic channels), limited primarily by the attenuation of optical signals.
Compared to LIDAR (e.g. using a series of LIDAR sensor heads across a city), the disclosed arrangements can monitor places where visual obstruction (e.g. underground, within a building or under bridges or flyovers) is present.
Compared to satellite imagery surveillance means which provide a birds-eye view from space, the disclosed arrangement is largely weather-independent and can monitor places where visual obstruction (e.g. underground, under thick clouds, within a building or under bridges or flyovers) is present, as well as providing live and dynamic as opposed to static data.
While image-based data has a higher resolution than acoustic data, the lower resolution of acoustic data has considerable advantages in terms of bandwidth and storage requirements, especially in the context of monitoring in real time a large urban geographic area

While the above non-acoustic sensing systems individually have their respective shortcomings, the present disclosure may be effectively combined with one or more of the above non-acoustic sensing systems to achieve an optimum outcome which includes higher resolution where necessary. Surveillance or monitoring data obtained from a non-acoustic sensing system may be represented together with the requested data obtained by the disclosed method and system. For instance, in the example of tracking the foot traffic of bus riders alighting at a bus interchange, the locations of individuals over time may be overlaid with an aerial map captured by satellite imagery. The combined representation may provide for more informed visualisation of how dispersed the particular group of bus riders are and, for example, adjustments to locations of bus stops may be correspondingly made. In another instance, in the example of tracking the potential jewellery thief, the tracked pedestrian path and the tracked vehicle path may be represented in the static street views obtained from the moving image capturing system. The combined representation may provide for more informed visualisation, such as providing visual cues to law enforcement personnel as to whether the potential jewellery thief would have walked or driven past locations of interest (e.g. a 24-hour convenience store where staff may be able to provide relevant information about the incident when interviewed).

When combining an acoustic sensing system with at least one non-acoustic sensing system, surveillance data may be obtained independently by the two systems to address shortcomings of each other or make surveillance information more granular than otherwise obtainable by either system alone. Based on the surveillance data obtained by one system, the other system may be requested to provide more specific surveillance information. In one arrangement, the surveillance information obtained from the non-acoustic sensing system is based on the requested information determined by the acoustic sensing system. For example, the acoustic sensing system provides requested data that two cars approaching an intersection collided at a specific instant (but not information regarding which driver is at fault), the CCTV surveillance system 118 and 119 may be used in conjunction to provide any footage capturing either set of the traffic lights presented to the corresponding driver (but not capturing the moment of the collision), at the time of the collision determined by the acoustic sensing system. By matching the times at which the surveillance information is obtained, the combined system may be used to determine the at-fault driver. There are many other examples where the visual and acoustic data may in combination provide valuable corroborating forensic and evidentiary information for legal and other purposes.

In another arrangement, the search request is addressed by delivering an interactive 3D virtual representation of a particular location similar to the 3D virtual presentation that is generated by the Street View function of Google Maps. In the arrangement described here, this would look like Google Maps Street View with a projection of real time moving symbols (particular sound objects) overlaid in the 3D interactive display where one can pan and tilt and move through the 3D view. This emulation could also include stereo sound for a sense of direction of real time sound the user is hearing. For example a search request could result in a user being able to view a particular street location with an computer generated visual emulation of all moving objects detected by the system augmented by the actual sound recorded by the system. Such a capability could assist a user in achieving rapid and comprehensive situational awareness of an area that would be an effective information tool for example for emergency response and law enforcement personnel.

The 3D virtual representation could also be a more comprehensive digital emulation/simulation of both the static objects (e.g. buildings, infrastructure, roads, foot paths, bridges) and the real time moving objects detected and classified in this disclosure (cars, trucks, pedestrians, bicycles, excavators, animals, as well as sub-classes of these objects, where feasible). This would allow a much more interactive immersion experience where an individual could move anywhere in the virtual environment, for example through doors, and see real time moving objects (e.g. pedestrians and traffic) and also hear directional sounds (via stereo channels) in the virtual environment at that location. An example of a more comprehensive digital emulation or simulation is the 3D building function of Google Earth in city centres where it is possible to overlay a digital emulation of all large buildings in 3D on the satellite imagery for a photo-realistic 3D image of a city.

In another arrangement, the search request is based on the surveillance information obtained from the at least one non-acoustic sensing system. For example, a satellite imagery system provides surveillance information that a person has entered a multi-level and multi-room building to undertake suspected criminal activities (but not surveillance information inside the building). Where an acoustic sensing system is in place within the building, a search request for tracking footsteps at a particular time from a particular building entry may be able to determine which level and which room the person is located. The determined information may allow law enforcement personnel to take corresponding action, such as sending enforcement personnel to the particular level and particular room.

In yet another arrangement the acoustic sensing and monitoring system is effectively combined with an existing mobile phone network in an urban environment where the mobile phone is GPS-enabled and uses Google Earth or a similar mapping and tracking application. An acoustic sensing app is provided which allows the user, in this case a pedestrian, to search for symbols of interest, or receive alerts of interest. For example an alert could be generated in the event of a car in the vicinity being driven dangerously or erratically. In another application a pedestrian could be alerted to areas where there are high incidences of shootings or collisions based on the retrieval and overlay of historic data generated by the acoustic sensing network.

It will be understood that the invention disclosed and defined in this specification extends to all alternative combinations of two or more of the individual features mentioned or evident from the text, examples or drawings. For example, any one or combination of the “what”, “when”, “where” and “who” may form the basis of the search request. Similarly, any one or combination of the “what”, “when”, “where” and “who” may form the basis of the determined information. All of these different combinations constitute various alternatives of the present disclosure.

It will also be understood that the implementation of the invention disclosed and defined in this specification will strictly take into account and comply with the laws relating to the privacy of data and data collection in all relevant jurisdictions. In this regard, all information relating to personal identification such as MAC addresses and registration plates will not be collected where this contravenes such laws and the capability of the technology to do so will accordingly be hobbled. In crime or security related applications where it is legal for third parties such as law enforcement or security agencies to collect such data typically through non-acoustic means such as cameras this third party data will be fused with the collected anonymous acoustic data with the express permission of such third parties and in compliance with privacy legislation.

1. An acoustic method of tracking and identifying trends or behavioural characteristics or properties of multiple sound producing targets or objects across a geographical area, independently of or as a supplement to bespoke tracking technology associated with such objects or targets, the method including:
repeatedly transmitting, at multiple instants, interrogating optical signals into each of one or more optical fibres distributed across the geographical area and forming at least part of an installed fibre-optic communications network;
receiving, during an observation period following each of the multiple instants, returning optical signals scattered in a distributed manner over distance along the one or more of optical fibres, the scattering influenced by acoustic disturbances caused by the multiple objects within the observation period;
demodulating acoustic data from the optical signals;
processing the acoustic data to identify tracks made by the objects over a period of time across the area;
analysing one or more characteristics of the tracks or tracked features, including start and end points, to identify relationship links between the dynamic objects and their locations or between the dynamic objects and other static or dynamic objects or fixtures or events in the geographic area for real time, historic or predictive analysis.

2. A method according to claim 1 which includes rendering dynamic real time representations of the objects and/or tracks on a GIS overlay or map.

3. A method according to either one of the preceding claims which includes identifying and correlating tracks made by the same object based on one or more characteristics of the tracks or the object to identify trends or behavioural characteristics of the object.

4. A method according to any one of the preceding claims wherein the characteristics of the tracks are selected from a group including, in addition to start and end points, at least one of the corresponding starting and end times acoustic signature classification, displacement, velocity and acceleration profile, inter-trip frequency, and time of travel.

5. A method according to any one of the preceding claims which includes the step of classifying the sound producing targets or objects or events as symbols representative of the sound producing targets or objects or events and storing the symbols as part of the datasets in a digital symbol index database.

6. A method according to any one of the preceding claims which includes generating alert criteria associated with respective acoustic signatures, and triggering an alarm or warning in the event of the alert criteria being triggered.

7. A method according to any one of the preceding claims wherein the one or more optical fibres include one or more unlit optical fibres or unused spectral channels in the installed urban or metropolitan fibre-optic communications network, and the fibre-optic communications network is a high density public telecommunications network approaching ubiquitous or substantially continuous street coverage.

8. A method according to any one of the preceding claims further including processing or fusing or representing the acoustic datasets together with surveillance data obtained from at least one non-acoustic sensing system.

9. A method according to claim 8 wherein classification data is obtained or a classification algorithm is trained using data from the at least one non-acoustic sensing system.

10. A method according to claim 8 or 9 wherein the non-acoustic sensing system includes at least one of a moving image capturing system, a machine vision system, a satellite-based navigation system including GPS, a satellite imagery system, a closed-circuit television system, a cellular signal based system, a Bluetooth system, inductive loop detectors, magnetic detectors, and location based social networks.

11. A method according to claim 6 in which the alert criteria are generated using a semantics engine to assess a threat or alert level associated with a target, and the alarm is generated in the event of the threat or alert level exceeding a threshold.

12. A method according to claim 10 in which registration data is fed into the semantics engine to enable threat or alert levels associated with registered objects to be reduced or filtered out.

13. An acoustic method of tracking and identifying trends or behavioural characteristics of multiple sound producing targets or objects in a geographical area, comprising:
sensing and locating at least one acoustic event;
identifying the event;
identifying one or more dynamic objects potentially associated with the event;
the identifying including tracking the one or more dynamic objects using a distributed acoustic sensor; using tracking information and/or non-acoustic data to establish or confirm relationship links between the dynamic objects and the event, and their locations, or between the dynamic objects and other static or dynamic objects or fixtures in the geographic area;
associating acoustic signatures with the dynamic objects using at least one non-acoustic sensor; and
storing the acoustic and non-acoustic data for retrieval and analysis.

14. An acoustic method according to claim 13 which includes processing the acoustic data and classifying it in accordance with target classes or types to generate a plurality of datasets including classification, temporal and location-related data; and storing the datasets in parallel with raw acoustic data which is time and location stamped so that it can be retrieved for further processing and matched with the corresponding datasets to provide real time, historic and predictive data.

15. An acoustic method according to claim 14 in which the optical data is processed into acoustic data at a resolution based on the temporal and location based parameters, the processing including retrieving the acoustic data at a desired resolution for near beam forming at a desired location, either historically or in real time.

16. An acoustic method according to any one of the preceding claims which includes detecting when tracking of one or more objects is suspended or ambiguated, and using a semantics engine to reactivate or disambiguate the tracking.

17. An acoustic method according to claim 16 when the tracking is ambiguated or suspended as a result of clustering of acoustic objects, including pedestrians or vehicles slowing down or stopping, and the semantics engine is configured to disambiguate or reactivate the tracking by assessing and comparing pre-and post-clustering conditions based on at least one of acoustic signatures, displacement, velocity or acceleration profiles, or non-acoustic identification means.

18. An acoustic method according to claim 16 when tracking is ambiguated or suspended as a result of acoustic objects temporarily no longer being acoustically detected, including pedestrians or vehicles moving away from network coverage, and the semantics engine is configured to disambiguate or reactivate the tracking by assessing and comparing pre-and post-non-detection conditions based on at least one of acoustic signatures, displacement, velocity or acceleration profiles, and geographic location based on map overlay.

19. An acoustic method according to any one of the preceding claims 13 to 15 wherein the acoustic event is an excavation event, the dynamic objects are excavators, the excavators being registered or unregistered depending on pre-recordal of excavation locations associated with the diggers being stored in a database, with excavation activity from non-registered diggers in the region of a fibre optic cable functioning as the distributed acoustic sensor being detected and responded to more rapidly than activity from registered diggers.

20. An acoustic method according to any one of the preceding claims 13 to 15 wherein the acoustic event is associated with an accident or crime scene, and the dynamic objects are vehicles and/or pedestrians.

21. An acoustic system for tracking and identifying trends or behavioural characteristics of multiple sound producing targets or objects across a geographical area, the system including:
an optical signal transmitter arrangement for repeatedly transmitting, at multiple instants, interrogating optical signals into each of one or more optical fibres distributed across the geographical area and forming at least part of an installed fibre-optic communications network;
an optical signal detector arrangement for receiving, during an observation period following each of the multiple instants, returning optical signals scattered in a distributed manner over distance along the one or more of optical fibres, the scattering influenced by acoustic disturbances caused by the multiple targets within the observation period;
a processing unit for demodulating acoustic data from the optical signals, for processing the acoustic data to identify tracks made by the objects over a period of time across the area; and for analysing one or more characteristics of the tracks, including start and end points, to identify relationship links between the dynamic objects and their locations or between the dynamic objects and other static or dynamic objects or fixtures in the geographic area for real time, historic or predictive analysis, and a storage unit for storing the acoustic data and the analysed datasets.

22. An acoustic system according to claim 21 for carrying out a method according to any one of claims 1 to 12.

23. An acoustic system for tracking and identifying trends or behavioural characteristics of multiple sound producing targets or objects across a geographical area, the system including:
a distributed acoustic sensor for sensing at least one acoustic event, the distributed acoustic sensor including
an optical signal transmitter arrangement for repeatedly transmitting, at multiple instants, interrogating optical signals into each of one or more optical fibres distributed across the geographical area and forming at least part of an installed fibre-optic communications network;
an optical signal detector arrangement for receiving, during an observation period following each of the multiple instants, returning optical signals scattered in a distributed manner over distance along the one or more of optical fibres, the scattering influenced by acoustic disturbances caused by the multiple targets within the observation period;
a processing unit configured to demodulate acoustic data from the optical signals, to process the acoustic data to locate the at least one acoustic event, to identify the event and to identify one or more dynamic objects potentially associated with the event,
wherein the identifying includes tracking the one or more objects using the distributed acoustic sensor and using tracking information and/or non-acoustic data to establish or confirm relationship links between the dynamic objects and the event, or between the dynamic objects and other static or dynamic objects or fixtures in the geographic area; and wherein the processing unit is further configured to associate acoustic signatures with at least one of the one or more dynamic objects using at least one non-acoustic sensor; and
a storage unit for storing the acoustic data, non-acoustic data and analysed datasets for retrieval and analysis.

24. An acoustic system according to claim 23 for carrying out a method according to any one of claims 13 to 19.
